(19) United States
(12) Patent Application Publication
(10) Pub. No.: US 2008/0270289 A1
(43) Pub. Date: Oct. 30, 2008

(54) Algorithmic trading system and method for testing automated trading of financial instruments

(75) Inventor: Donato Petrino, Weiterstadt (DE)

Correspondence Address: Cynthia Smith;RTS Realtime Systems Inc., Ste #980, 311 South Wacker Dr., Chicago, IL, 60606, US

(73) Assignee: RTS Realtime Systems Software GmbH, Frankfurt/Main (DE)

(21) Appl. No.: 12/148,957

(22) Filed: Apr. 24, 2008

Related U.S. Application Data
(60) Provisional application No. 60/925,984, filed on Apr. 24, 2007.

(51) Int. Cl. G06Q 40/00

(52) U.S. Cl. 705/37

(57) ABSTRACT

Provided is an algorithmic trading system and method for testing automated trading of financial instruments, or for “back-testing”, an executing trading strategy of the algorithmic trading system. An executing trading strategy is formed by processing a generated trading strategy. The generated trading strategy is formed by compiling a created trading strategy. The created trading strategy includes a rule for automated trading, a parameter value for each of at least one parameter and a trading strategy name. The rule includes the at least one parameter and at least one of an order agent and a quote agent.

### CROSS-REFERENCE TO RELATED APPLICATIONS

This application claims benefit under 35 U.S.C. §119(e) of a U.S. Provisional Application entitled “An Algorithmic Trading System and Method for Testing Automated Trading of Financial Instruments”, filed on Apr. 24, 2007, having application No. U.S. 60/925,984, which is related to a Continuation-in-Part application concurrently filed on Apr. 24, 2007, where the Continuation-in-Part application is related to a National Stage application, also concurrently filed, of International Application No. PCT/EP2005/012384, entitled Algorithmic Trading System, A Method for Computer-Based Algorithmic Trading and Computer Program Product, having an International Filing Date of Nov. 18, 2005, which designated the United States of America.

### BACKGROUND OF THE INVENTION

The present invention generally relates to algorithmic trading, and more specifically to an algorithmic trading system and method for testing automated trading of financial instruments.

Computerized electronic trading of financial instruments such as stocks/equities, bonds, futures, options, currencies, warrants, commodities, etc., has replaced much of the traditional open-outcry floor trading. In general, such electronic trading of financial instruments is facilitated using computer network schemes that may include servers hosted by one or more electronic trading exchanges (e.g., CME, CBOT, EUREX), communication servers and/or networks, and end-user computers or electronic terminals having at least one input means (e.g., a keyboard, a mouse). Other schemes that facilitate electronic trading of financial instruments may include an Alternative Trading System(s) (ATS) or an Electronic Communication Network(s) (ECN). For ease of discussion, the servers and networks hosted by one or more trading exchanges and/or an ECN(s) and/or an ATS(s) are herein referred to as host system(s) or “electronic market place server(s)”, and the front-end computers or electronic terminals are herein referred to as “client terminals”.

Operations provided by the electronic market place server(s) may include maintaining trade order books of trade orders (“orders”), facilitating trade order-matching (“trades”), price discovery and market data distribution for the online trading day as well as nightly batch runs. The electronic market place server(s) may also be equipped with external interfaces that maintain uninterrupted online contact to quote vendors and other price information systems. In general, an order may be defined as an instruction to buy or sell a quantity of a financial instrument at a certain price or better. Similarly, a quote is generally defined as a pair instruction to buy and sell a quantity of a financial instrument at respective certain prices or better.

Electronic market place servers are typically communicatively coupled to any number of client terminals via, for example, corresponding external gateways and/or provider server equipment. Among other things, software included with the provider server equipment and the external gateways enables the electronic trading interface between the electronic market place server(s) and the client terminal(s). Users accessing the host system(s) via a client terminal may include investment banks, proprietary trading firms, individual traders, hedgefunds, brokers, commodity trading adviser (CTA), market makers/specialists, on-line brokers, corporations, clearing companies and the like.

Any number of communication networks between the client terminal, the provider server equipment and the electronic market place server facilitate user access to the host system. Once access is established, orders and quotes initiated by the user are formatted in packetized messages for bidirectional transmission between their client terminal and host system using a suitable protocol. Such protocols may include TCP/IP, UDP/IP. X.25, SDLC, or equivalent protocols.

A user typically utilizes front-end client software to generate specialized interactive trading screens on the display of his/her client terminal. The interactive trading screen and an associated input device (e.g., computer mouse) allows the user to obtain market data, enter orders, enter quotes, confirm trades and monitor positions. While faster than traditional floor trading, the speed at which orders and/or quotes are initiated at the client terminal is limited by a user's “human” reaction time (e.g., pointing and clicking). This limitation becomes more apparent as larger number of orders and/or quotes are required to be initiated in a short time period.

Unlike a few years ago, in order to profit in the electronic market places, especially those hosting volatile financial instruments (i.e., financial instruments with rapidly fluctuating prices), a user must be able to react more quickly. As a result, algorithmic trading systems providing automated trading have been developed to overcome limitations of human reaction time. In general, an algorithmic trading system enables a user to express his/her trading strategy ideas as a software coded algorithm, which when compiled and executed, automatically performs the trading tasks previously initiated by the user. The user therefore is no longer required to manually initiate each individual order or quote. Additionally, prior to deployment, a prudent user of such an algorithmic trading system may test his/her executing software coded algorithm using previously collected market data or other suitable financial data.

As those who have tried can attest to, creating a software coded algorithm based on trading strategy idea can be very time consuming, expensive and inefficient when using standard programming languages such as C or C++. In fact, by the time conversion to a computer readable trading strategy is complete, the underlying trading strategy idea may have been rendered obsolete by market changes. Additionally, such standard programming languages generally require extensive programming skills, thereby rendering most algorithmic trading systems out of reach for the individual user/trader.

### SUMMARY OF THE INVENTION

Provided is an algorithmic trading system and method for testing automated trading of financial instruments, or for “back-testing” an executing trading strategy of the algorithmic trading system. The algorithmic trading system for testing automated trading of financial instruments includes a server, a data player, and at least one exchange simulator operatively coupled to the data player and the server computer. The server computer is adapted to store a rule for automated trading, where the rule includes at least one parameter and at least one order agent and/or quote agent. The server computer is also adapted to store a created trading strategy, where the created trading strategy includes the rule, the parameter value for each of the at least one parameter and a trading strategy name. The server computer is further adapted to compile the created trading strategy to form a generated trading strategy, and to process the generated trading strategy to form an executing trading strategy adapted to automatically cause a trading output. The executing trading strategy is adapted to automatically cause the trading output in response to an exchange simulator output, where the exchange simulator output is generated by the exchange simulator(s) in response to receipt of data from the data player. The data includes at least one of market data, order data, quote data, trade data and position data, where the market data is reconstructed by the data player from stored incremental market data changes previously collected from an electronic market place server.

### BRIEF DESCRIPTION OF THE DRAWINGS

FIG. 1 is a block diagram of an exemplary algorithmic trading system for automated trading of financial instruments, according to an embodiment of the invention.

FIG. 2 is a more detailed block diagram of the algorithmic trading server computer of FIG. 1.

FIG. 3 is a detailed functional diagram of the algorithmic trading server computer of FIG. 2, including creation, and initiation, generation and execution of a trading strategy, according to an embodiment of the invention.

FIG. 4 an exemplary screen shot of a rule development client, including a rule editor screen, of the client computer of FIG. 1, according to an embodiment of the invention.

FIG. 5 is an exemplary screen shot of a trading client of the client computer of FIG. 1, according to an embodiment of the invention.

FIG. 6 is an exemplary screen shot of a create strategy editor of the trading client of FIG. 5, according to an embodiment of the invention.

FIG. 7 is another exemplary screen shot of the trading client of FIG. 5, including a pull-down menu associated with each created, generated and executing trading strategy.

FIG. 8 is a block diagram of the algorithmic trading system of FIG. 1, further including “back-testing” capability for an executing trading strategy.

FIG. 9 is a block diagram of the algorithmic trading system of FIG. 1, further including “parallel back-testing” of a number of executing trading strategies.

FIG. 10 is a screen shot of a close-up view of the back-test pull-down menu of FIG. 11.

FIG. 11 is an exemplary screen shot of a backtest run editor, selectable via the pull-down menu of the trading client of FIG. 5.

FIG. 12 is another exemplary screen shot of the backtest run editor of FIG. 11.

FIG. 13 is an exemplary screen shot of a backtest run strategy generator displayed to the user upon selection of a generate variations button of the backtest run editor of FIG. 12, according to an embodiment of the invention.

FIG. 14 is another exemplary screen shot view of the backtest run editor of FIG. 11, including a list of the trading strategy variations to be back-tested, according to an embodiment of the invention.

FIG. 15 is another exemplary screen shot of the trading client of FIG. 5, including a copy to back-test pull-down menu.

FIG. 16 is screen shot of a close-up view of the copy to back-test pull-down menu of FIG. 15.

FIG. 17 is the screen shot of FIG. 16 further including display of a user selectable backtest runs menu item, according to an embodiment of the invention.

FIG. 18 is a screen shot of an exemplary back-test run list that is displayed upon user selection of the backtest runs menu item of FIG. 17.

FIG. 19 is a screen shot of an exemplary backtest run result view that is displayed upon user selection of an entry and a show results button of the exemplary back-test run list of FIG. 18.

FIG. 20 is an exemplary screen shot of another version of the backtest run result view of FIG. 19, additionally including an interactive back-test run timeline.

### DETAILED DESCRIPTION OF THE PREFERRED EMBODIMENTS

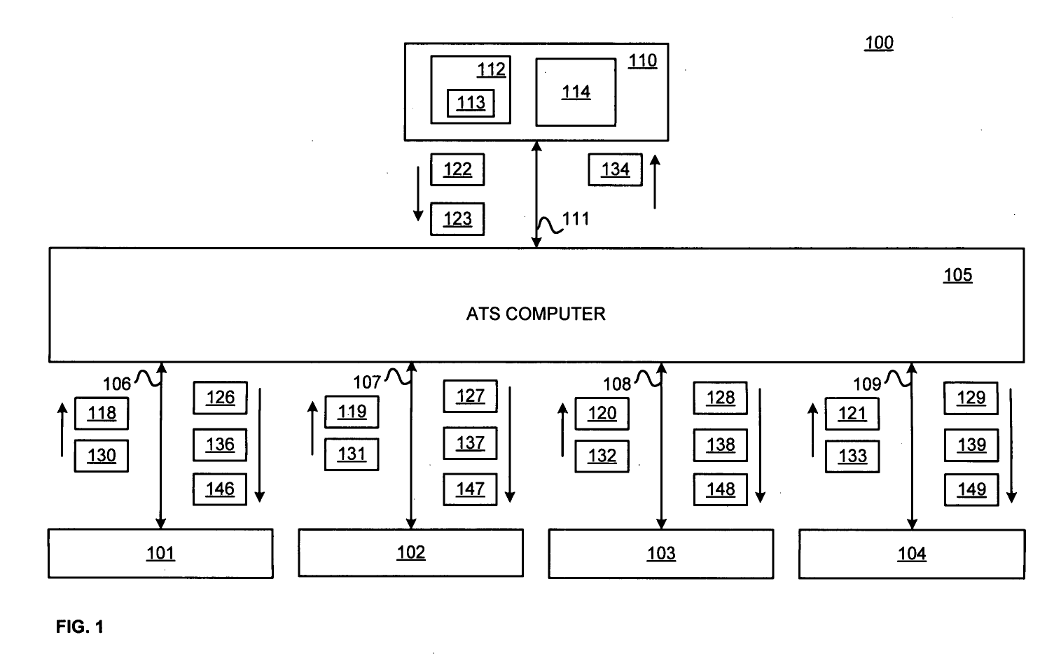

FIG. 1 is a block diagram of an exemplary algorithmic trading system 100 for automated trading of financial instruments, according to an embodiment of the invention. The financial instruments can include stocks, equities, futures, options, commodities, bonds, currency and warrants.

Referring to FIG. 1, the algorithmic trading system 100 includes an algorithmic trading server (ATS) computer 105 operatively coupled to a number of electronic market place servers 101-104, (e.g., a number of stock exchange servers) and at least one client terminal 110. Each of the electronic market place servers 101-104 is coupled to the ATS server 105 by means of a respective communication connection 106, 107, 108, 109. The communication connections 106, 107, 108, 109 may be established as a Wide Area Network (WAN), a mobile radio communication network and/or a fixed communication network. Similarly, the client terminal 110 is coupled to the ATS server 105 via a communication connection 111. While enabled via a local area network (LAN) connection, it is contemplated that the communication connection 111 may be enabled via any of the communication connections described above. Although only four are shown, more or less electronic market place servers 101-104 may be included in the algorithmic trading system 100. Similarly, although only one client terminal 110 is shown, more may be included in the algorithmic trading system 100.

Each of the electronic market place servers 101-104 includes an exchange order book that “lists” bid orders and ask orders for all of their respective traded financial instruments. The lists of bid and ask orders are provided by the electronic market place servers 101-104 to the ATS computer 105 as data (e.g., market data) via market data messages 118, 119, 120, 121.

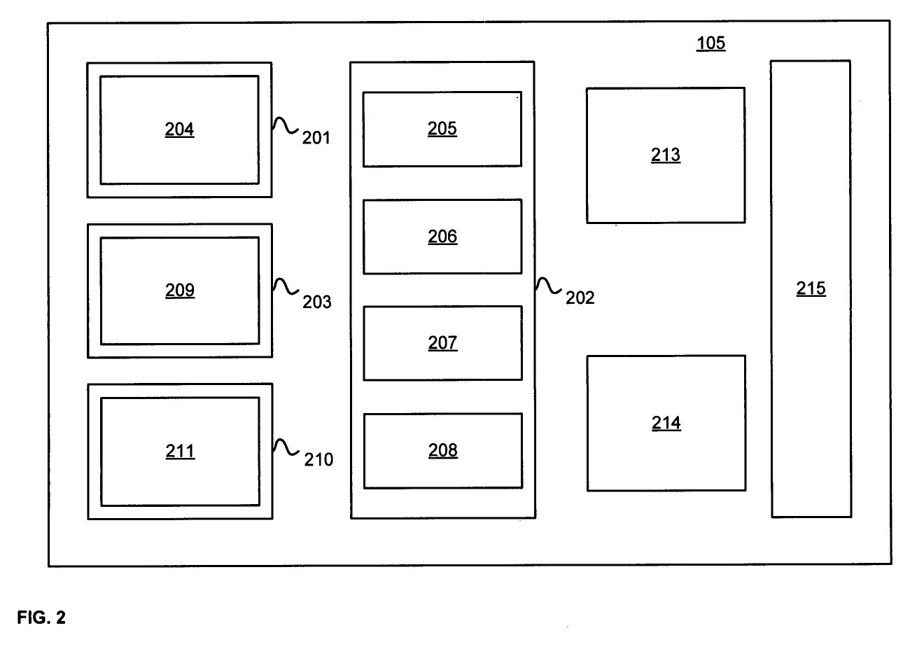

The market data messages 118, 119, 120, 121 are received and stored by the ATS computer 105 in a market data memory 201 (see FIG. 2).

When an electronic market place server 101-104 executes a received order, it generates and transmits a respective execution notification message 130, 131, 132, 133 to the ATS computer 105.

FIG. 2 is a more detailed block diagram of the ATS computer 105. In general, the ATS computer 105 is adapted to enable a user at the client terminal 110 to develop, compile, execute and test his/her trading strategy idea, according to an embodiment of the invention. Referring to FIG. 2, the ATS computer 105 includes a market data memory 201, a rule memory 202, a parameter value memory 203, a strategy memory 210, a strategy generation unit 213, an interpreter 214 and a transmitting/ receiving unit 215. The receiving/transmitting unit 215 is inter alia configured to communicate with the electronic market place servers 101-104 and the client terminal 110, according to their respectively required communication protocols.

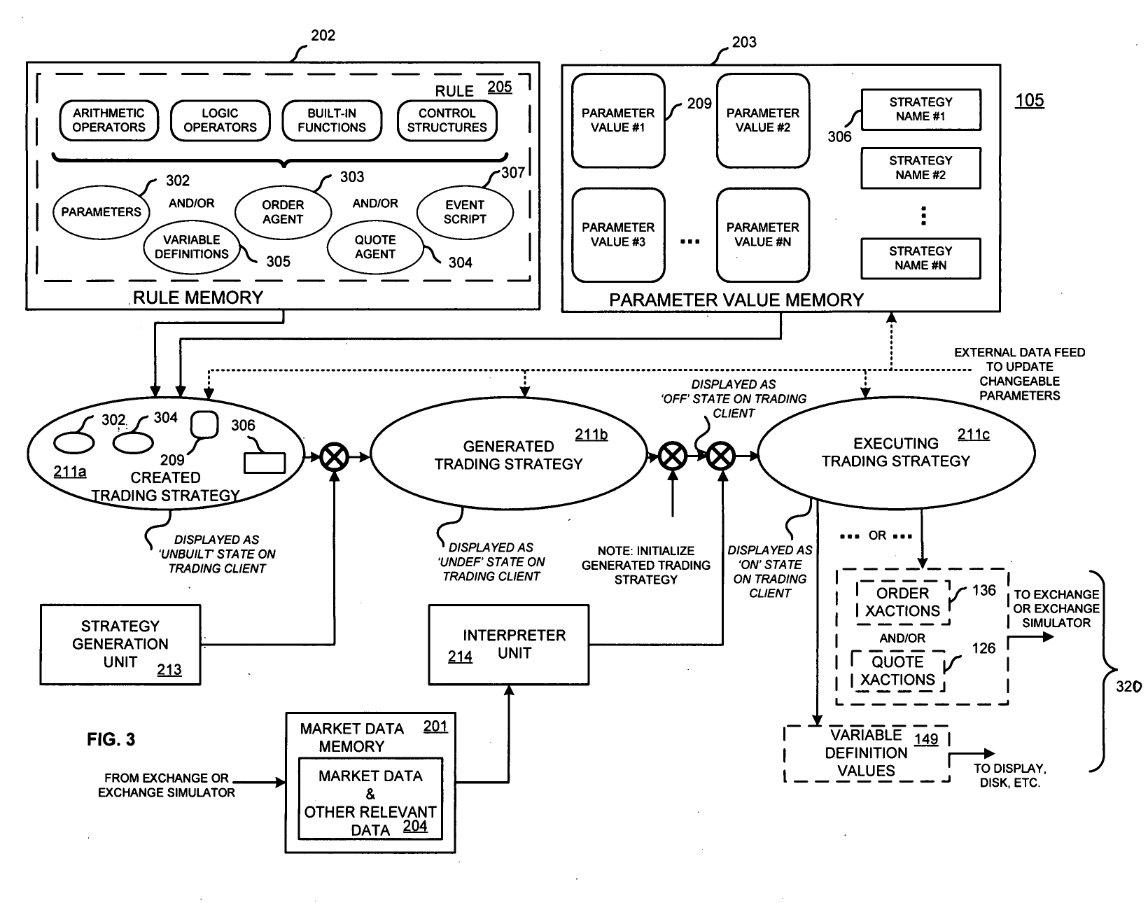

FIG. 3 is a detailed functional diagram of the ATS computer 105, including creation, and initiation, generation and execution of a trading strategy, according to an embodiment of the invention. Referring to FIG. 3, the rule memory 202 is adapted to store one or more rules such as the rules 205, 206, 207, 208 (see, FIG. 2) for automated trading. Each rule includes one or more parameters 302 and at least one of an order agent 303, a quote agent 304, a variable definition 305, an event script 307 and an off condition.

The parameter value memory 203 is adapted to store a number of user-entered trading strategy names such as a trading strategy name 306 (e.g., Strategy Name #1). The parameter value memory 203 is also adapted to store a number of user-entered parameter values for each of the parameters included in a rule such as the rule 205. For example, a parameter value 209, associated with the parameter 302 of the rule 205, is stored in the parameter value memory 203.

Referring to FIGS. 2 and 3, the strategy memory 210 is adapted to store one or more created trading strategies where each includes, for example, a number of parameter values and a quote agent. In the illustrated example, a created trading strategy 211 a includes the rule 205 having the quote agent 304, the parameter value 209 for the parameter 302, and a trading strategy name 306.

The strategy generation unit 213 is configured to compile the created trading strategy 211a to form a generated trading strategy 211b. The generated trading strategy 211b is associated with one instance of, or one instantiation of, the rule 205.

Conversion of the created trading strategy 211a to a compiled or generated trading strategy 211b requires that the created trading strategy 211 a in the strategy memory 210 be acted upon by the strategy generation unit 213 as follows: First the strategy generation unit 213 performs a syntax validation and type checking of the created trading strategy 211a. Next, the strategy generation unit 213 converts the human-readable representation of the created trading strategy 211a into computer-readable pseudo code representation of the created trading strategy 211a, also referred to herein as the generated trading strategy 211b. In this context, the expressions (i.e., the right side) of the human-readable representation of the variable definitions, the parameters, the agents, the event scripts and the off condition are converted into a corresponding expression class within the pseudo code representation, (e.g., a number expression class, a Boolean expression class, etc.) These expression classes are abstract base classes. An object model is provided for the abstract base classes.

The interpreter unit 214 is configured to process the generated trading strategy 211b to form an executing trading strategy 211c. The executing trading strategy 211c automatically causes a trading output to be generated in response to receipt of data 204 by the interpreter unit 214. In conjunction with the transmitting/ receiving unit 215, the interpreter unit 214 is also configured to facilitate bidirectional communication between the ATS computer 105, the client computer 110 and one or more electronic market place servers 101-104. Each of the generated and executing trading strategies 211b and 211c, as well as other generated and executing trading strategies are also stored in the strategy memory 210.

The usage of the interpreter unit 214 further enables the user to amend parameter values of individual trading strategies during the concurrent run-time of a large number of executing trading strategies. A trading strategy with the amended parameter values may then be re-compiled and re-interpreted.

Furthermore, as described above, the ATS computer 105 receives updated market data by means of market data messages 118, 119, 120, 121 from respective electronic market place servers. If the market data in a received market data message 118, 119, 120, 121 results in a change in the expressions and/or conditions within one or more executed trading strategies, the interpreter unit 214 determines the changes and re-evaluates the values of all related variable definitions within all executed trading strategies. If a change is determined, the respective order agent performs the corresponding order transaction (or a corresponding quote transaction) such that the order state at the electronic market place server is synchronized with the state represented by the local variables of the order agent.

Depending on the agents, the variable definitions, etc., of the executing trading strategy 211c, and using the data extracted from the stored market data messages 118-121, the trading output to respective electronic market place servers 101-104 may include a plurality (or message stream) of order transaction messages 126-129, a plurality of quote transaction messages 136-139, and/or a plurality of variable definition values 146-149, as illustrated in FIG. 1.

For example, while executing the generated trading strategy 211c, the trading output to the electronic market place server 101 may include order transaction messages 126, quote transaction messages 136 and/or variable definition values 146.

More specifically, while executing the generated trading strategy 211c, the order agent 303 (see, FIG. 3) determines the values of its local variable definitions (i.e., the order agent variables, quote agent variables) and depending on the values may:
generate and transmit an add order command via the order transaction message 126 to add an order to the electronic market place server 101; upon receipt of the order transaction message 126 to add an order, the electronic market place server 101 enters the respective order into its order book;
generate and transmit a change order command via the order transaction message 126 to change an order that has already been entered at the electronic market place server 101; upon receipt of the order transaction message 126 to change an order, the electronic market place server 101 changes the respective order in its order book accordingly;
generate and transmit a delete order command via the order transaction message 126 to delete an order that has already been entered at the electronic market place server 101; upon receipt of the order transaction message 126 to delete an order, the electronic market place server 101 deletes the respective order from its order book.

Similarly, during execution of the trading strategy, a quote agent such as the quote agent 304 transmits quote transaction messages 136 to add, delete and change quotes.

Turning now to the interpreter unit of FIG. 2, the data 204 it receives may include market data, order data, quote data, trade data, position data or any other relevant financial instrument data. For example, the data may include:
Bid order data, representative of each bid order (e.g., price and quantity of the traded financial instrument) for each of the traded financial instrument,
Accumulated bid order data representative of accumulated bid orders (e.g., price and accumulated quantity of the traded financial instrument) for each of the traded financial instrument,
Ask order data, representative of each ask order (e.g., price and quantity of the traded financial instrument) for each of the traded financial instrument,
Accumulated ask order data, representative of accumulated ask orders (e.g., price and accumulated quantity of the traded financial instrument) for each of the traded financial instrument,
Last traded price data that represents the most recent traded price for each of the traded financial instrument,
Last traded quantity data that represents the most recent traded quantity for each of the traded financial instrument, and
Total turnover data that represents the total traded quantity for each of the traded financial instrument.

While configured as separate blocks of the ATS computer 105, it is contemplated that the functionality of the market data memory 201, a rule memory 202, a parameter value memory 203, a strategy memory 210, a strategy generation unit 213, an interpreter 214 and a transmitting/receiving unit 215 may be implemented in any number of suitable configurations, not separately shown.

Referring again to FIG. 1, the client computer 110 includes a rule development client 112 and a trading client 114 to enable the user to perform a number of tasks, for example, (i) developing a rule such as the rule 205, (ii) entering parameter values and strategy names such as the parameter value 209 and the strategy name 306, and (iii) initiating compilation, execution and/or testing of his/her trading strategy idea. Although illustrated as two functional blocks in the client computer 110, it is contemplated that the functionality of the rule development client 112 and/or the trading client 114 may be implemented in multiple client computers 110.

As discussed above in connection with FIG. 3, the parameter values 209 are stored in the parameter value memory 203. When received via a user input, the parameter values 209 are transmitted from the client computer 110 to the ATS computer 105 via the associated communication connection 111. Such parameter value(s) are transmitted to the ATS computer 105 in a respective parameter value message, illustrated as parameter value message(s) 123 in FIG. 1.

In addition to the parameter values 209, the parameter value message 123 also includes instructions for generation of the trading strategy (e.g., instantiation of the rule 205 with the parameter values 209 and the strategy name 306). Upon receipt of the parameter value message 123, the ATS computer 105 determines and stores parameter values 209 in the parameter value memory 203. The ATS computer 105 also determines the instructions for trading strategy creation and then creates the trading strategy 211a according to the determined instructions. The created trading strategy 211a is stored in the strategy memory 210 and also displayed in a list on the trading client 114.

Similarly, when completed, user developed rules, such as the rule 205, are transmitted from the client computer 110 to the ATS computer 105 in a rule message 122. Upon receipt of the rule message 122, the ATS computer 105 stores the developed rule 203 in a rule memory 202, or “rule library”. The developed rule 203 is also displayed in a list on the rule development client 112.

During trading strategy execution, the ATS computer 105 generates and transmits market monitoring data in market monitoring data messages 134 to the client computer 110 for display via the trading client 114. The user can then monitor the trading output to determine the effects of his/her executing strategy or strategies. If necessary, the user can amend the executing trading strategy or strategies in response to information included in the market monitoring data message 134.

In general, the rule development client 112 is adapted to enable the user, using a high level pre-defined syntax, to create and edit rules (aka, algorithms), that are based on a trading strategy idea or concept. Once developed, the rule is much like a code template, which when compiled with selected parameter values and a unique strategy name, form a generated trading strategy. The rules, the parameter values and the unique strategy names are stored in a human readable format (e.g., XML/Text).

Referring to FIGS. 1 and 3, the pre-defined syntax used for rule development makes use of parameters 302, order agents 303, quote agents 304, variables definitions 305, event scripts 307 and off conditions (not separately illustrated). When developing a rule, the user minimally utilizes at least one parameter and at least one agent. Typically however, the user will utilize a number of parameters, at least one agent, at least one event script, a number of variable definitions and an off condition.

More specifically, the rule development client 112 is adapted to enable a user to create the rule 205 using arithmetic operators, logic operators, built-in functions and control structures, and to display the rule 205 via a rule editor 113. The built-in functions are predefined functions which are stored in a function library (i.e., the rule memory 202) and can be called during run-time, also referred to herein as trading strategy execution. The rule development client 112 is further adapted to display a rule template via the rule editor 113 for use in creating the rule 205.

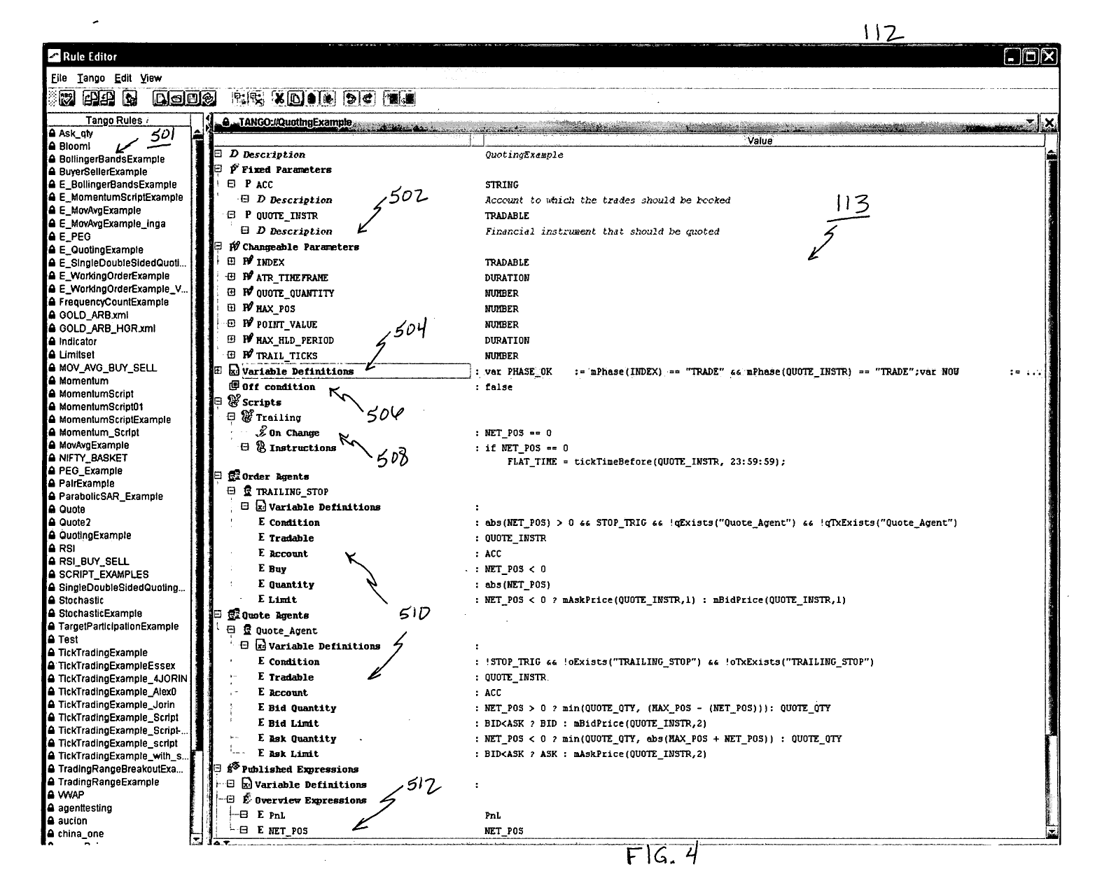

FIG. 4 an exemplary screen shot of the rule development client 112, including the rule editor 113, according to an embodiment of the invention. The rule development client 112 includes a list of developed rules 501 on the right hand side and the rule editor 113 on the left hand side. The rule editor 113 includes a parameter template portion 502, a variable definition template portion 504, an off condition template portion 506, a script template portion 508, an agent template portion 510, and a published expressions template portion 512. The published expressions template portion 512 enables the user to select a number of variable definition values 313 (discussed below) to be displayed on the trading client 114 during a runtime of, for example, the executing trading strategy 211c.

The off condition template portion 506 is provided in the rule editor 113 for predefining one or more Boolean expressions. When an off condition(s) evaluates to TRUE, the associated executing trading strategy is stopped or simply not started, and all entered orders are automatically deleted, (i.e., corresponding order delete messages are generated and transmitted to the corresponding electronic market place server 101-104). In the illustrated example, the off condition is illustrated as an absolute value of the first variable CURR_POS and the parameter MAX_POS.

For example, the user desiring to implement the following trading strategy idea as a rule may use the rule development client 112 as follows:

For purposes of illustrative background information, it is assumed that the electronic market place server 101 provides a market depth for each of its traded financial instrument. The market depth is displayed to the user via the client terminal 110 as a bid list of current pending bid prices with corresponding bid quantities, and an ask list of current pending ask prices with corresponding ask quantities. The market depth is updated as, for example, orders are placed, orders are matched (trades) with quotes or other orders, etc.

Such a market depth might be visualized for a financial instrument A as follows:

### Financial Instrument A

| | | | | Ask |
|---|---|---|---|---|
| Bid Quantity | Bid | Level | Ask | Quantity |
| 1000 | 100.00 | 1 | 101.00 | 500 |
| 1200 | 99.50 | 2 | 101.20 | 400 |
| 1300 | 99.15 | 3 | 102.50 | 850 |
| 430 | 98.75 | 4 | 103.75 | 1150 |

As illustrated, at Level 1, there exists at least one bid order for buying 1000 units of the financial instrument A at a price of 100.00. There also exists at least one ask order for selling 500 units of the financial instrument A at a price of 101.00, and so on.

In the example trading strategy idea, it is required that a bid order should be generated to buy the financial instrument A each time the ask price at level 1 is less than or equal to a first predefined value, and that an ask order should be generated to sell the financial instrument A each time the bid price is greater than or equal to a second predefined value.

As discussed above, the predefined syntax is a high-level language syntax facilitating creation of parameters (definitions and values), variable definitions, order agents, quote agents, event scripts and off conditions via the rule editor 113 of the rule development client 112. In accordance with this example, the user formulates and creates a rule in the predefined syntax using arithmetic operators, logic operators, built-in functions and control structures.

The parameters include Boolean types, number types, string types, time point types, time duration types, or other predefined types. The parameters may be fixed parameters, (i.e., parameters that cannot be changed during run-time of the executing trading strategy 211c) or changeable parameters (i.e., parameters that can be changed during run-time of the executing trading strategy 211c). For example, a fixed parameter, “INSTR”, may be used to indicate the financial instrument to which the trading rule refers. A changeable parameter, “BUY_LIMIT”, may be used to indicate a maximum limit of an ask order price at which the financial instrument is to be bought according to the rule.

The variable definitions are named logic placeholders (e.g., CURR_POS) in a rule. Each variable definition is associated with either an expression reference (e.g., CURR_POS:=pLong(INSTR, ACC)−pShort(INSTR, ACC) or an expression value (e.g., CURR_POS=pLong(INSTR, ACC) or pSHort (INSTR, ACC) not illustrated in the example). Referring again to FIG. 4, the variable definitions are classified into two variable definition types where the type depends on when their values are calculated. A referential variable definition, signified by “:=” indicating an expression reference, has its value calculated and/or updated real time (based on its expression reference) during execution of an associated trading strategy. A state variable definition, signified by “=” indicating an expression value, where once assigned, has its value recalculated only when instructed to via an event script of the executing trading strategy. Variable definitions may be of a Boolean type, a number type, a string type, a time point type, a time duration type, or another predefined type.

An expression may include arithmetic operators (such as “+”, “−”, “*”, “/”, “modulo”), and/or logic operators (such as “AND”, “OR”, “NOT”). Furthermore, control structures may be included in the expressions such as “IF THEN . . . ELSE”, “WHILE . . . DO”, or “FOR . . . DO”. In addition, an expression may include the built-in functions.

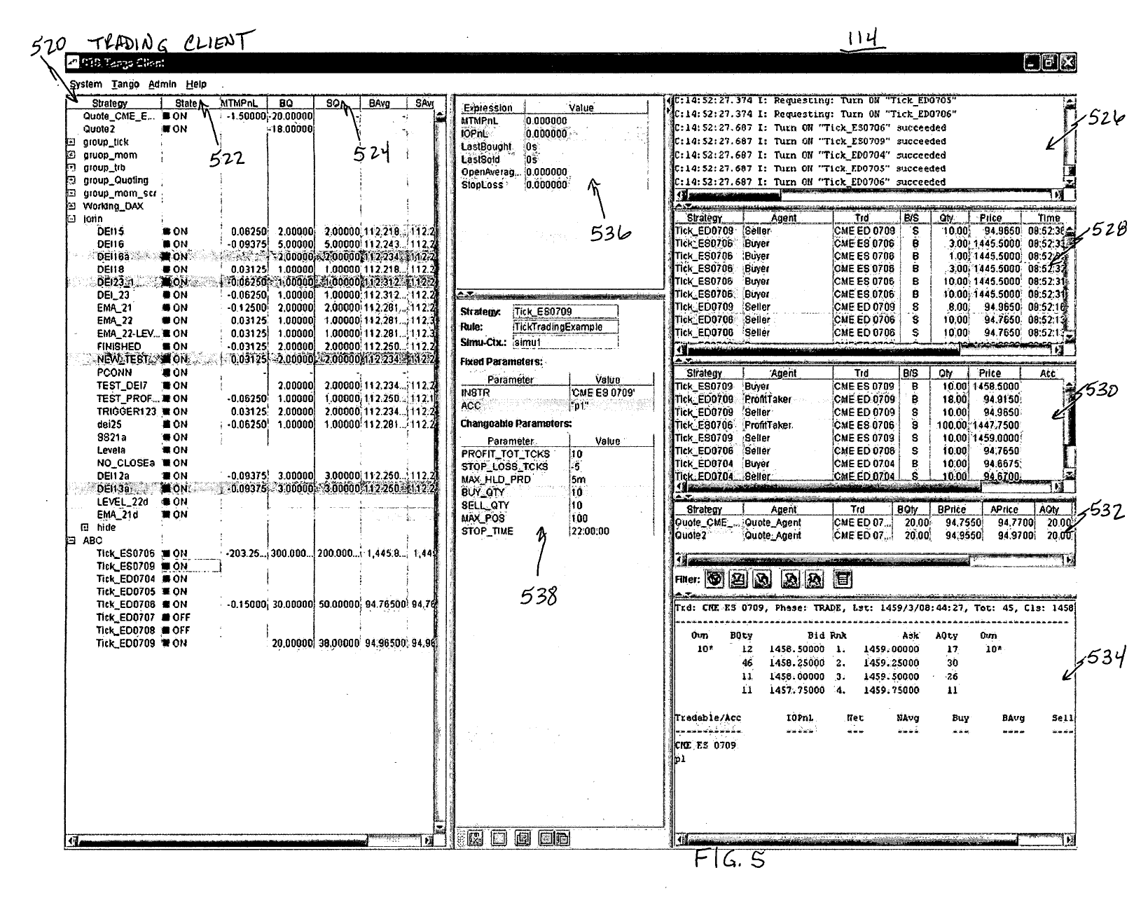

An event script is an optional script that is triggered upon the happening of a defined event during trading strategy execution. For example, use of the event script 307 may cause reassignment of both state variables and referential variables upon an occurrence of a triggering event such as a value change of at least one of a so called “OnChange” expression. Using OnChange expression(s) in event scripts, complex events can be programmed as triggers for scripts in a generic way. For example, using the OnChange expression: mLastPrice(INSTR); NOW>15:00:00 Script code:, the event script executes the code each time either of the values of the expressions “mLastPrice(INSTR)” or “NOW>15:00:00” change. Use of the event script 307 may also enable a state variable definition to become a referential variable definition, and vice versa. When included in a generated trading strategy, the event script 307 must be first initialized prior to executing that trading strategy as discussed in FIGS. 3 and 5.

Referring again to FIG. 3, the order agent 303 is a user-named logic unit adapted to perform order transaction management (via order transaction messages) including issuing and managing order additions, order deletions and order changes for one or more orders. Similarly, the quote agent 304 is a user-named logic unit adapted to perform quote transaction management (vie quote transaction messages) including issuing and managing quote additions, quote deletions and quote changes one or more quotes.

Use of the order agents and quote agents while developing a rule reduces the time it takes for the user to convert a trading strategy idea into the rule. This is due, in part, to the abstraction from the technical details of how order/quote management is performed by the electronic market place servers 101-104. By utilizing order and quote agent(s) 303, 304, the user does not need to program exchange specific asynchronous protocols when developing a rule; the agent(s) already include such technique-related code.

Additionally, the use of fixed strategy parameters, changeable strategy parameters, by-reference variable calculation and by-value variable calculation enables CPU efficiency during trading strategy execution. Such efficiency is the result of a reduction in the number of variable value recalculations that are required to be performed, as compared with traditional algorithmic trading systems where recalculations are triggered by every market event (e.g., tick change). Such CPU efficiency also allows for inter alia, concurrent executing trading strategies.

In the following paragraphs, the syntax of a rule representing the above-described trading strategy idea, and referred to herein as “Rule 1”, will be described in more detail:

Rule 1: “ElectronicEye”

| Fixed Parameters: | | |
|---|---|---|
| INSTR | | TRADABLE |
| ACC | | STRING |
| Changeable Parameters: | | |
| BUY_LIMIT | | NUMBER |
| SELL_LIMIT | | NUMBER |
| MAX_POS | | NUMBER |
| Variable Definitions: | | |
| CURR_POS | := | pLong(INSTR, ACC) − pShort(INSTR, ACC) |
| BUY_OPP | := | BUY_LIMIT >= mAskPrice(INSTR, 1) |
| SELL_OPP | := | SELL_LIMIT <= mBidPrice(INSTR, 1) |

Order Agent: “Buyer”

| | | |
|---|---|---|
| trd | := | INSTR |
| acc | := | ACC |
| buy | := | true |
| qty | := | min(mAskQty(INSTR, 1), |
| | | MAX_POS − CURR_POS) |
| lmt | := | mAskPrice(INSTR, 1) |
| cnd | := | BUY_OPP |

Order Agent: “Seller”

| | | |
|---|---|---|
| trd | := | INSTR |
| acc | := | ACC |
| buy | := | false |
| qty | := | min(mBidQty(INSTR, 1), |
| | | MAX_POS + CURR_POS) |
| lmt | := | mBidPrice(INSTR, 1) |
| cnd | := | SELL_OPP |

| | |
|---|---|
| Off condition := | abs(CURR_POS) > MAX_POS |

In this example, Rule 1 is denoted with a unique-defined name, in this case “ElectronicEye”.

The left Parameter column denotes the name of the respective parameter and the right Parameter column comprises the type (e.g., NUMBER, STRING) of the assigned parameter.

For example, the first fixed parameter INSTR (which denotes the financial instrument to which the Rule 1 refers) is of the type TRADABLE (which denotes a tradable financial instrument).

Moreover, the second fixed parameter ACC (which denotes the trading account) is of the type STRING.

The first changeable parameter BUY_LIMIT is of the type NUMBER. The BUY_LIMIT denotes the maximum limit of the ask order price at which the financial instrument A should be bought according to the rule. If the ask order price is less than or equal to the BUY_LIMIT, a buy order will be triggered; in other words, the BUY_LIMIT represents the maximum price the user is willing to pay for the financial instrument A.

The second changeable parameter SELL_LIMIT is of the type NUMBER. The SELL_LIMIT denotes the minimum limit of the bid order price at which the financial instrument A should be sold according to the rule. If the bid order price is greater or equal to the SELL_LIMIT, a sell order will be triggered; in other words, the SELL_LIMIT represents the minimum price at which the user is willing to sell the financial instrument A.

The third changeable parameter MAX_POS defines the position limit range, (i.e., the maximum aggregated quantity of the financial instrument A that the trader may be long or short).

The left Variable Definition column denotes the name of the respective variable definition and the right Variable Definition column displays the expression that is used for determining the value of the assigned variable definition.

The first variable definition CURR_POS is the current position of the financial instrument A. The current position is determined by the difference between the purchased amount of the financial instrument A (pLong(INSTR, ACC)) and the sold amount of the financial instrument A (pShort(INSTR, ACC)). The CURR_POS is a variable definition that evaluates to a NUMBER and therefore the value of the first variable definition is a NUMBER expression.

The second variable definition BUY_OPP is defined as a comparison of the first changeable parameter BUY_LIMIT to the built-in function mAskPrice (INSTR, 1), which represents the ask order price of the financial instrument A at the market depth of level 1. The second variable definition BUY_OPP evaluates to a BOOLEAN value and is TRUE when the value of the first changeable parameter BUY_LIMIT is greater than or equal to the ask order price of the financial instrument A at the market depth of level 1, and is FALSE in any other case.

The third variable definition SELL_OPP is defined as a comparison of the second changeable parameter SELL_LIMIT to the built-in function mBidPrice (INSTR, 1), which represents the bid order price of the financial instrument A at the level 1 market depth. The third variable definition SELL_OPP evaluates to a BOOLEAN value and is TRUE when the value of the first changeable parameter SELL_LIMIT is less than or equal to the bid order price of the financial instrument definition at the level 1 market depth, and is FALSE in any other case.

In this context, it should be noted that pLong(x, y), pShort(x, y), mAskPrice(x, y) and mBidPrice(x, y) are examples of built-in functions, (i.e., they are functions that are provided to create the rule). Other examples of built-in functions include:
mLastPrice(x):
   this number function returns the price of the last trade of the financial instrument x;
mLastQty(x):
   this number function returns the quantity of the last trade of the financial instrument x;
oExists(x):
   this Boolean function returns TRUE if the order agent with the name x has an order and returns FALSE otherwise;
pLongAvg(x, y):
   this number function returns the average price of the bought financial instrument x with respect to account y;
pShortAvg(x, y):
   this number function returns the average price of the sold financial instrument x with respect to account y;
mBidQty(x, y):
   this number function returns the bid order quantity of the financial instrument x at the level y of the market depth;
mAskQty(x, y):
   this number function returns the ask order quantity of the financial instrument x at the level y of the market depth.

Referring back to the Rule 1 example, a first order agent with the name “Buyer” is defined via a number of buyer order agent variables, including:
a first buyer order agent variable “trd” (of type TRADABLE), where the first fixed parameter INSTR is assigned to the first buyer order agent variable;
a second buyer order agent variable “acc” (of type STRING), where the second fixed parameter ACC is assigned to the second buyer order agent variable;
a third buyer order agent variable “buy” (of type BOOLEAN), where the third buyer order agent variable is TRUE in order to denote that the first order agent should have the function to continually buy if the condition given below is met;
a fourth buyer order agent variable “qty” (of type NUMBER), where the fourth buyer order agent variable denotes the quantity that should respectively be bought by the first order agent if a bid order is generated; in this embodiment, the fourth buyer order agent variable is determined by the minimum of either the quantity of the ask order of level 1 (mAskQty(INSTR, 1)) or the difference between the parameter MAX_POS and the first variable CURR_POS;

a fifth buyer order agent variable “lmt” (of type NUMBER), where the fifth buyer order agent variable denotes the price limit at which the first order agent should generate bid orders for buying the financial instrument; in this embodiment, the fifth buyer order agent variable is determined using the built-in function mAskPrice(INSTR, 1);
a sixth buyer order agent variable “cnd” (of type BOOLEAN), where the sixth buyer order agent variable denotes the condition under which the first order agent should generate bid orders for buying the financial instrument; in this embodiment, the second variable BUY_OPP is assigned to the sixth buyer order agent variable.

The first order agent generates a bid order when the second variable definition BUY_OPP is TRUE. In this case, a bid order is generated with the values according to the respective current values of above described order agent variables. As long as the value of the sixth buyer order agent variable “cnd” is TRUE, the first order agent is responsible for generating the bid order and amending the generated bid order in response to the continuously monitored resulting value of the related variables, which are included in the first order agent. In other words, when a bid order has been generated with a first price limit at a first time instant and, assuming that the market depth changes, (e.g., mAskPrice(INSTR, 1)), the value of the sixth buyer order agent variable changes to a second price limit at a second time instant. A bid order change message (e.g., the order transaction message 136) is generated by the first order agent and transmitted to a respective electronic market place server 101-104 in order to change the entered bid order from the first price limit to the second price limit. Furthermore, when the sixth buyer order agent variable “cnd” becomes FALSE, the first order agent generates a corresponding bid order delete message and transmits it to the appropriate electronic market place server(s) 101-104 in order to delete the entered bid order.

In Rule 1, a second order agent with the name “Seller” is also defined via a number of seller order agent variables, including:
a first seller order agent variable “trd” (of type TRADABLE), where the first fixed parameter INSTR is assigned to the first seller order agent variable;
a second seller order agent variable “acc” (of type STRING), where the second fixed parameter ACC is assigned to the second seller order agent variable;
a third seller order agent variable “buy” (of type BOOLEAN), where the third seller order agent variable is FALSE in order to denote that the second order agent should have the function to continuously sell if the condition given below is met;
a fourth seller order agent variable “qty” (of type NUMBER), where the fourth seller order agent variable denotes the quantity that should respectively be sold by the second order agent if an ask order is generated; in this embodiment, the fourth seller order agent variable is determined by the minimum of either the quantity of the bid order of level 1 (mBidQty(INSTR, 1)) or the sum of the parameter MAX_POS and the first variable CURR_POS;
a fifth seller order agent variable “lmt” (of type NUMBER), where the fifth seller order agent variable denotes the price limit at which the second order agent should generate ask orders for selling the financial instrument; in this embodiment, the fifth seller order agent variable is determined using the built-in function mBidPrice(INSTR, 1);
a sixth seller order agent variable “cnd” (of type BOOLEAN), where the sixth seller order agent variable denotes the condition under which the second order agent should generate ask orders for selling the financial instrument; in this embodiment, the third variable SELL_OPP is assigned to the sixth seller order agent variable.

Ask orders are generated by the second order agent generates in a similar fashion to generation of bid orders by the first order agent.

In an alternative embodiment of the invention, the functions of the first order agent and the second order agent may be combined into one common order agent having the function of both, either generating a bid order or an ask order. In this case, the respective expressions, generally the respective logic, would have to be adjusted accordingly.

In a further embodiment, in addition to or as an alternative to the order agent(s), one or more quote agents may be provided in the rule for quote transaction management including generating, amending and deleting quotes via corresponding quote transaction messages 136 transmitted to its corresponding electronic market place server 101-104.

Another trading strategy idea may be based on so called tick trading, where the strategy goal is to achieve gains through incremental moves back and forth between buying and selling the same financial instrument.

In the following paragraphs, the syntax of a tick trading rule representing the above-described trading idea and referred to herein as Rule 2, will be described in more detail below:

Rule 2: “TickTrading”

| | |
|---|---|
| Fixed Parameters: | |
| INSTR | TRADABLE |
| ACC | STRING |

Changeable Parameters:

| | |
|---|---|
| PROFIT_TARGET | NUMBER |
| QTY | NUMBER |
| MAX_POS | NUMBER |

Variable Definitions:

| | | |
|---|---|---|
| CURR_POS | := | pLong(INSTR, ACC) − pShort(INSTR, ACC) |

| | | |
|---|---|---|
| SHORT_OP_AVG | := | eShortLastAvg(INSTR, ACC, |
| | | abs(CURR_POS)) |
| LONG_OP_AVG | := | eLongLastAvg(INSTR, ACC, |
| | | abs(CURR_POS)) |

Order Agent: “Buyer”

| | | |
|---|---|---|
| trd | := | INSTR |
| acc | := | ACC |
| buy | := | true |
| qty | := | min(QTY, MAX_POS − CURR_POS) |
| lmt | := | mBidPrice(INSTR, 1) |
| cnd | := | CURR_POS >= 0 |

Order Agent: “Seller”

| | | |
|---|---|---|
| trd | := | INSTR |
| acc | := | ACC |
| buy | := | false |
| qty | := | min(QTY, MAX_POS + CURR_POS) |
| lmt | := | mAskPrice(INSTR, 1) |
| cnd | := | CURR_POS <= 0 |

Order Agent: “ProfitTaker”

| | | |
|---|---|---|
| trd | := | INSTR |
| acc | := | ACC |
| buy | := | CURR_POS < 0 |
| qty | := | abs(CURR_POS) |
| lmt | := | buy ? SHORT_OP_AVG − |
| | | PROFIT_TARGET : LONG_OP_AVG + |
| | | PROFIT_TARGET |
| cnd | := | CURR_POS != 0 |

| | |
|---|---|
| Off condition := | abs(CURR_POS) > MAX_POS |

The left Parameter column denotes a name of the respective parameter and the right Parameter column defines the type of the assigned parameter.

In the example described above, the first fixed parameter INSTR (denotes to which financial instrument the Rule 2 refers) is of the parameter type TRADABLE.

The second fixed parameter ACC (which denotes the trading account) is of the parameter type STRING.

A first changeable parameter PROFIT_TARGET is of the type NUMBER and denotes the amount to be gained within one buy and sell transaction.

A second changeable parameter QTY is of the type NUMBER and denotes the quantities with which the bid order or ask order are entered by the Buyer order agent or Seller order agent, respectively.

The third changeable parameter MAX_POS defines the position limit range, (i.e., the maximum aggregated quantity of the financial instrument A that the trader may be long or short).

The left Variable Definition column in each case denotes the name of the respective variable definition and the right Variable Definition column comprises the expression that is used for determining the value of the assigned variable definition.

In the example of Rule 2, the first variable definition CURR_POS is defined as the current position with respect to the financial instrument A. The current position is determined by the difference between the purchased amount of the financial instrument A (pLong(INSTR, ACC)) and the sold amount of the financial instrument A (pShort(INSTR, ACC)). The CURR_POS is a variable definition that evaluates to a NUMBER and therefore the value of the first variable definition is a NUMBER expression.

In the example described above, a second variable definition SHORT_OP_AVG is defined by the built-in function eShortLastAvg(INSTR, ACC, abs(CURR_POS)), which returns the average price of the current short position. The second variable definition SHORT_OP_AVG is a variable definition that evaluates to a NUMBER.

A third variable definition LONG_OP_AVG is defined by the built-in function eLongLastAvg(INSTR, ACC, abs(CURR_POS)), which returns the average price of the current long position. The third variable definition LONG_OP_AVG is a variable that evaluates to a NUMBER.

A first order agent “Buyer” of the Rule 2 example is defined by means of a plurality of buyer order agent variables, namely:
a first buyer order agent variable “trd” (of type TRADABLE), where the first fixed parameter INSTR is assigned to the first buyer order agent variable;
a second buyer order agent variable “acc” (of type STRING), where the second fixed parameter ACC is assigned to the second buyer order agent variable;
a third buyer order agent variable “buy” (of type BOOLEAN), wherein the third buyer order agent variable is TRUE in order to denote that the first order agent should have the function to constantly buy if the condition given below is met;

the fourth buyer order agent variable “qty” denotes a quantity that should be purchased by the first order agent if a bid order is generated; in this embodiment, the fourth buyer order agent variable is determined by the minimum of either the fifth changeable parameter QTY or the first variable CURR_POS;

the fifth buyer order agent variable “lmt” is the result of the built-in function mBidPrice(INSTR, 1);

the sixth buyer order agent variable “cnd” evaluates TRUE if the first variable CURR_POS is greater than or equal to “0” and FALSE otherwise.

A second order agent with the name “Seller” is defined by means of a plurality of seller order agent variables, namely:
a first seller order agent variable “trd” (of type TRADABLE), where the first fixed parameter INSTR is assigned to the first seller order agent variable;
a second seller order agent variable “acc” (of type STRING), where the second fixed parameter ACC is assigned to the second seller order agent variable;
a third seller order agent variable “buy” (of type BOOLEAN), where the third seller order agent variable is FALSE in order to denote that the second order agent should have the function to constantly sell if the condition given below is met;
a fourth seller order agent variable “qty” (of type NUMBER) denotes the quantity that should respectively be sold by the second order agent if an ask order is generated; in this embodiment, the fourth order agent variable is determined by the minimum of either the fifth changeable parameter QTY or the sum of the first variable CURR_POS and the parameter MAX_POS;
the fifth seller order agent variable “lmt” (of type NUMBER) denotes the price limit at which the second order agent should generate ask orders for selling the financial instrument; in this embodiment, the fifth seller order agent variable is determined using the built-in function mAskPrice(INSTR, 1);
the sixth seller order agent variable “cnd” (of type BOOLEAN) denotes the condition under which the second order agent should generate ask orders for selling the financial instrument; in this embodiment, the sixth seller order agent variable evaluates to TRUE if the first variable CURR_POS is less than or equal to “0” and FALSE otherwise.

According to this embodiment of the invention, an additional third order agent “ProfitTaker” is provided which includes the following order agent variables:
a first profit taker order agent variable “trd” (of type TRADABLE), where the first fixed parameter INSTR is assigned to the first profit taker order agent variable;
a second profit taker order agent variable “acc” (of type STRING), where the second fixed parameter ACC is assigned to the second profit taker order agent variable;
a third profit taker order agent variable “buy” (of type BOOLEAN), where the third profit taker order agent variable is a comparison of the first variable CURR_POS with the value “0”; in this embodiment, the third profit taker order agent variable evaluates to TRUE if the first variable CURR_POS is less than “0” and FALSE otherwise;
a fourth profit taker order agent variable “qty” (of type NUMBER), where the fourth profit taker order agent variable denotes the quantity that should respectively be bought by the third order agent if the third profit taker order agent variable “buy” is TRUE, thereby generating a bid order, or that should respectively be sold by the third order agent if the third profit taker order agent variable “buy” is FALSE, thereby generating an ask order; in this embodiment, the fourth profit taker order agent variable is the absolute value of the first variable CURR_POS;
a fifth profit taker order agent variable “lmt” (of type NUMBER), where the fifth profit taker order agent variable denotes the price limit at which the third order agent should generate bid orders and ask orders for buying or selling the financial instrument depending on the third profit taker order agent variable “buy”; if the third profit taker order agent variable “buy” is TRUE, the third order agent should generate bid orders with a limit that results as the difference between the second variable SHORT_OP_AVG and the first changeable parameter PROFIT_TARGET; if the third profit taker order agent variable “buy” is FALSE, the third order agent should generate ask orders with a limit that results as the sum of the third variable LONG_OP_AVG and the first changeable parameter PROFIT_TARGET; a sixth profit taker order agent variable “cnd” (of type BOOLEAN), where the sixth order agent variable denotes the condition under which the first order agent should generate bid orders for buying the financial instrument or the condition under which the first order agent should generate ask orders for selling the financial instrument; in this embodiment, the sixth profit taker order agent variable evaluates to TRUE if the first variable CURR_POS is not equal to “0”.

In this embodiment, it is assumed that if the first variable definition CURR_POS is initially “0”, the first order agent “Buyer” is generating a bid order with a limit that corresponds to the level 1 of the current market depth for the financial instrument A, where the bid order the order book of the respective electronic market place server 101-104 in the level 1 position. The second order agent “Seller” performs the analogous actions with regard to the ask order side. The third order agent “ProfitTaker” becomes active when either the bid order or the ask order is executed by the respective electronic market place server 101-104. In this case, the third order agent “ProfitTaker” generates an order that is opposite to the order that was previously executed with such a limit that the first changeable parameter PROFIT_TARGET is tried to be gained.

In alternative embodiments, any suitable rule may be implemented within the ATS computer 105. It should also be noted that variations of the below described rules are contemplated according to alternative embodiments of the invention:
Pairs trading rule:
   A trading rule in which two financial instruments are traded such that they are related to one another, where a difference between two very similar financial instruments that are highly correlated is exploited.
Volume Weighted Average Price (VWAP):
   VWAP is calculated by adding up the money traded for every transaction (price times shares traded) and then dividing by the total shares traded for the day; the theory is that if the price of a buy trade is lower than the VWAP, it is a good trade; the opposite is true if the price is higher than the VWAP.
Strategies that take into account so called Bollinger bands.

In general, any trading strategy idea can be expressed in the above-manner, even by a user with no extraordinary skills in programming.

In an alternative embodiment, the human-readable representation of the created trading strategy may be directly be transformed into its executable machine code.

Referring again to FIGS. 2 and 3, the trading client 114 is adapted to display a list of created, generated and executing trading strategies. Each of the created, generated and executing trading strategies of the list is selectable by the user. The trading client 114 also enables the user to select existing rules, to enter the selected parameter values and to enter unique strategy names.

The trading client 114 is further adapted to enable compilation initiation of a user-selected created trading strategy, to enable initialization of a user-selected generated trading strategy prior to processing by the interpreter unit, and to enable processing initiation of the user-selected generated trading strategy after initialization. Moreover, the trading client 114 is adapted to enable user selection of the rule and user input of the parameter value and the trading strategy name to form a “created trading strategy” such as the created trading strategy 211a.

The trading client 114 is additionally configured to provide a means for amending the parameter values of 209 of a trading strategy, and for providing information about the results of the trading strategy via a graphical interface so that the user can monitor the effects and the state of the executing trading strategy 211c.

FIG. 5 is an exemplary screen shot of the trading client 114 of the automatic trading system of FIG. 1, according to an embodiment of the invention. In the illustrated example, the trading client 114 includes a list of trading strategies 520 on the left-hand side. Each trading strategy is associated with a state, listed in a State column 522, and a number of user-selectable overview published expressions 524. Each entry in the State column 522 reflects a current state of the associated trading strategy. The state may be one of an ‘Unbuilt’ state, an ‘Undef’ state, an ‘Off’ state, and an ‘On’ state.

The ‘Unbuilt’ state indicates a human-readable created trading strategy, such as the created trading strategy 211a of FIG. 2. The ‘Undef’ state indicates (conversion of the created trading strategy 211a to) a generated trading strategy such as the generated trading strategy 211b. Prior to execution, a generated trading strategy must be initialized in order to initialize any included variable definitions (representing a trading strategies initial state). This initialization will set the variable definition values in accordance with their assignments reflected in the variable definitions portion of an underlying rule. In this configuration, the associated entry in the State column 522 indicates a state of ‘Off. The interpreter unit 214, interpreting an initialized generated trading strategy, including the base classes representing function-like objects for determining the order/quote attributes to form the executing trading strategy, is associated with an ‘On’ state. The On state indicates that any included order and/or quote agents are active. For example, after initialization, the generating trading strategy 211b may reflect an ‘Off state, and upon interpretation, the state changes to ‘On’, indicating the executing trading strategy 211c. It should be understood however, that after initialization and while in an Off state, there may be cases where the interpreter unit 214 may begin interpreting to process an event script(s) in order to update variable definition values. Although described in terms of the various state indicators in the State column 522, it should be understood that other visual indications may be used to inform the user of the status of his/her trading strategies shown in the list of trading strategies 520.

The top right-hand side of the trading client 114 of FIG. 5 includes a message log file window 526 adapted to display activity messages (e.g., error messages, warning messages, initiating trading strategies, changing variables). Below the message log file window 526 is a series of additional windows including a filled orders window 528 adapted to display completed/matched orders and/or quotes, a working orders window 530 adapted to display current working orders, a working quotes window 532 adapted to display current working quotes, and a market depth overview window 534 adapted to display a trade summary of a trading strategy selected from the list 520. Among other things, the trade summary includes market depth, working orders, a summary of buy and sell quantities, and average prices, net position and closed P/L.

A user wishing to create a trading strategy associated with a particular developed rule, for example, the rule 205, can access the ATS computer 105 via the trading client 114. Choosing a “create strategy” entry via a pull-down menu 550, selectable from the tool bar of the trading client 114, invokes display of a “Create Strategy” editor.

Although configured as described above, it is contemplated that the exemplary screen shot of FIG. 5 is only one of any number of suitable configurations that may be displayed via the trading client 114.

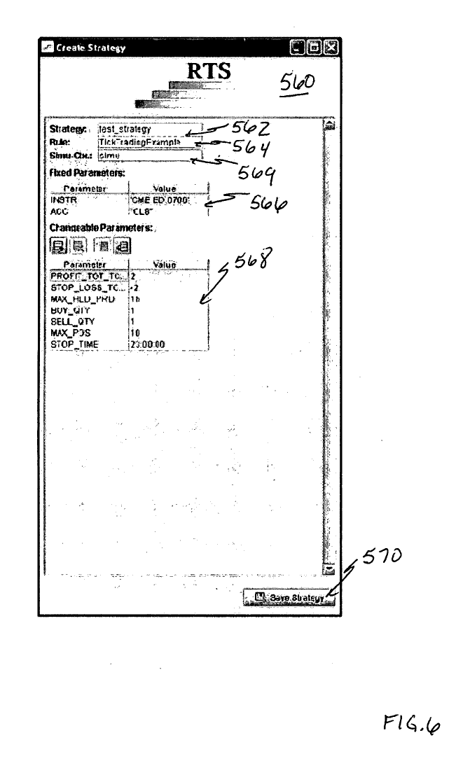

FIG. 6 is an exemplary screen shot of a create strategy editor 560 of the trading client 114, according to an embodiment of the invention. As illustrated in FIG. 6, the create strategy editor 560 includes a number of text boxes. A first text box 562 enables the user to type in a strategy name such as the strategy name 306. The second text box 564 includes a drop down menu displaying a number of developed rules, including, for example, the stored rule 205. A fixed parameter multi-entry text box 566 and a changeable parameter text box 568 enables user-entry of parameter values associated with the rule displayed in the second text box 564. That is, the fixed parameter multi-entry text box 566 and a changeable parameter text box 568 enable the user to specify the particulars of the STRINGS, BOOLEANS, etc. previously identified (see, FIG. 4) in the selected rule via the Rule editor 112. The selected rule, in conjunction with the parameter value(s) and the strategy name are then used to create the trading strategy upon selecting a “save strategy” button. For example, user selection of the rule 205 via the text box 564, in conjunction with parameter value 209 entry and strategy name 306 entry, enables creation of the trading strategy 211a upon clicking on the save strategy button 570 at the bottom of the create strategy editor 560. Another text box 569 allows the user to specify whether the created trading strategy is for simulation purposes or not.

Referring again to FIG. 5, the center of the trading client 114 includes two center windows; a first center window 536 is configured to display user-selected detailed published expressions, and a second center window 538 is configured to enable the user to view the parameter details, the strategy and rule name details of a trading strategy selected from the list 520. Selecting different trading strategies displayed in the list 520 yields their associated user-selected detailed published expressions, parameter details, and the strategy and rule name details. Once displayed in the second center window 538, parameter details can be edited. In this way a user can change parameters on the fly, without returning to the rule editor 113 of FIG. 4. A number of panic buttons 540 are also provided on the trading client 114 of FIG. 5 to enable the user to stop/suspend execution of one or more trading strategies.

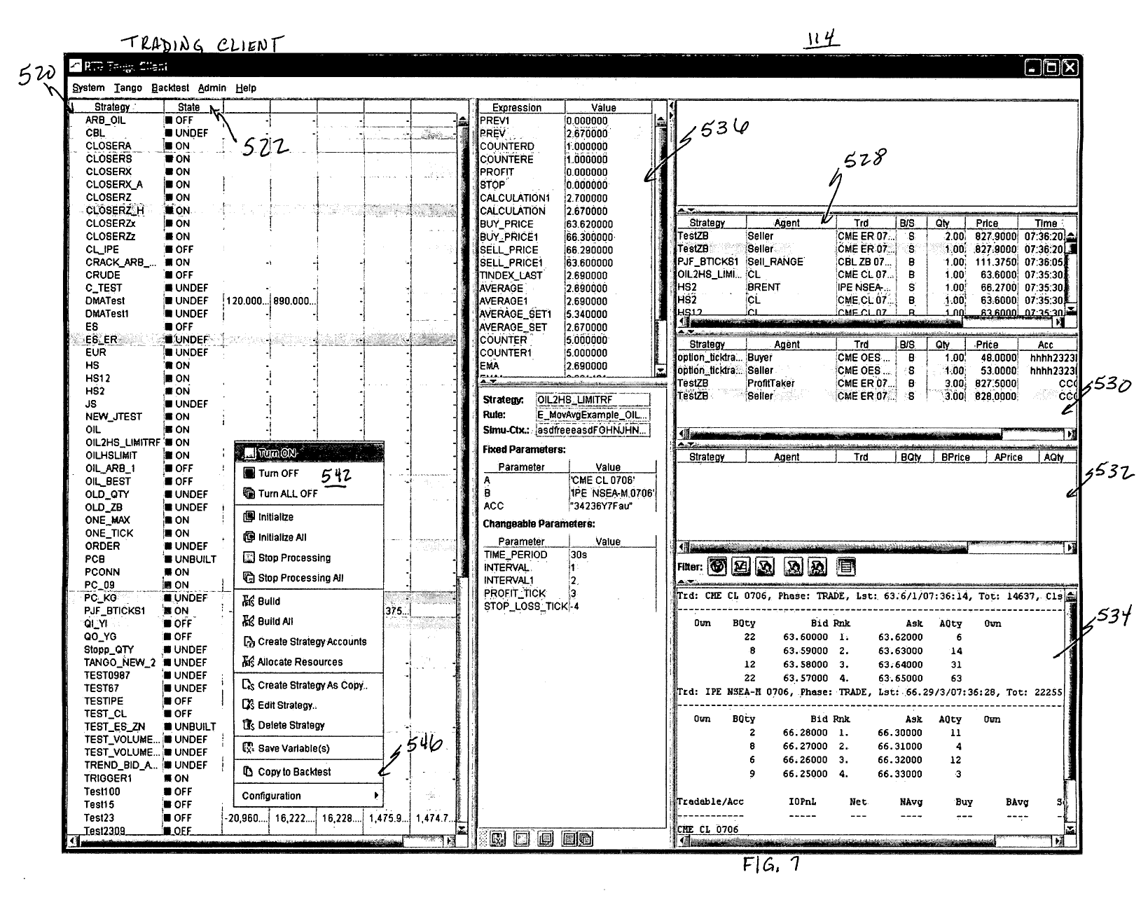

FIG. 7 is another exemplary screen shot of the trading client 114, including a pull-down menu 542 associated with each created, generated or executing trading strategy. The pull-down menu 542 includes a variety of entries, which when individually selected, allow the user to initiate the tasks described above (e.g., compile via selecting the build entry, execute via selecting the ON entry, etc.). For example, the user wishing to begin compilation of a trading strategy selects the trading strategy from the list 520 using a mouse pointer. Once selected, a right mouse click invokes display of the pull-down menu 542, from which the build entry can be selected.

As described above, the algorithmic trading system and method includes testing capability for automated trading of financial instruments; that is, the algorithmic trading system described herein provides a method for “back-testing” an executing trading strategy. For ease of discussion a “back-test run” may be defined as a test of one or more executing trading strategies using previously collected data.

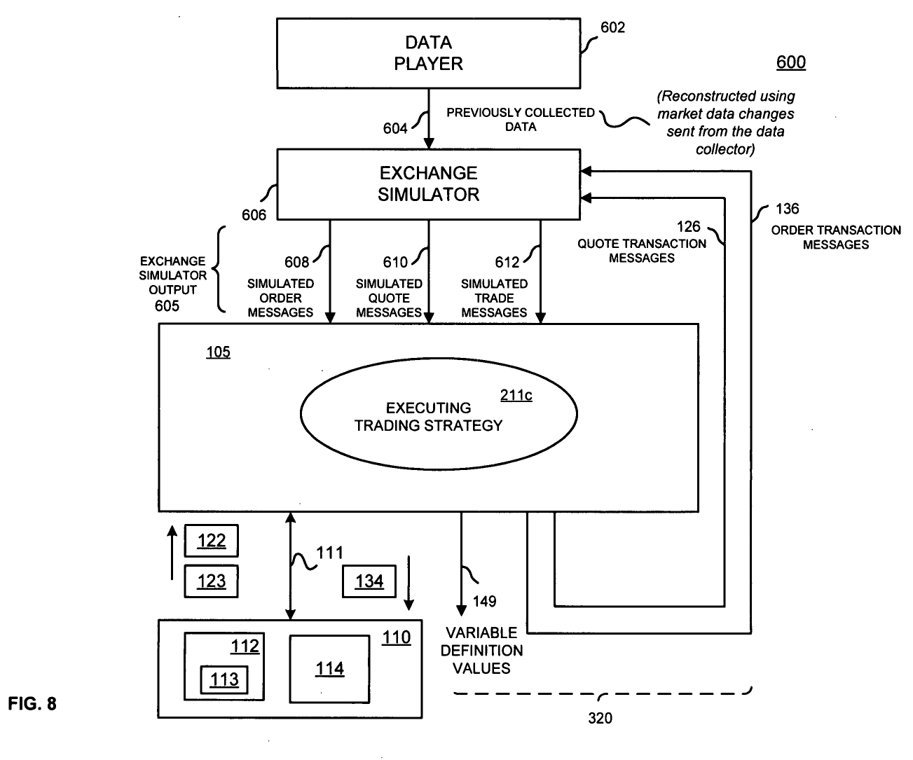

FIG. 8 is a block diagram of another algorithmic trading system 600, further including “back-testing” capability for an executing trading strategy, according to an embodiment of the invention. Like the algorithmic trading system 100, the algorithmic trading system 600 includes the ATS computer 105 as well as all of the functionality described in connection with FIGS. 2, 3, 4, 5, 6, 7 and 10 (described below). Unlike the algorithmic trading system 100, the ATS computer 105 of the algorithmic trading system 600 is not communicatively coupled to a number of electronic market place servers 101-104. Rather, the ATS computer 105 of the algorithmic trading system 600 is communicatively coupled to an exchange simulator 606, which is communicatively coupled to a data player 602. While illustrated as separate blocks for ease of discussion, it should be understood that the functionality of the ATS computer 105, the exchange simulator 606, and the data player 602 may be combined into one component (e.g., the ATS computer 105), or may be configured in another suitable fashion.

In general, the algorithmic trading system 600 enables the user to back-test executing trading strategies using previously collected data, including market data, in a defined time period. For each executing trading strategy, such back-testing includes logical testing of the associated underlying rule, and performance testing to optimize associated parameter values.

More specifically, the exchange simulator 606 causes an exchange simulator output 605 in response to receipt of previously collected data 604 (e.g., market data) from the data player 602. Upon receipt of the exchange simulator output 605, the ATS computer 105, executing a trading strategy causes the trading output 320. Initially, the trading output 320 includes at least one of a plurality of order transaction messages 126, a plurality of quote transaction messages 136 and a plurality of variable definition values 146, while the exchange simulator output 605 simply includes the previously collected data 604. At this time, the exchange simulator 606 has not yet received an order or quote transaction messages (i.e., no feedback to the exchange simulator 606). Upon receipt of the trading output 320 and the exchange simulator output 605 at a next instant however, the trading output 320 includes at least one of a different plurality of order transaction messages 126, a different plurality of quote transaction messages 136 and a different plurality of variable definition values 146, while the exchange simulator output 605 includes at least one of a plurality of simulated order messages 608, a plurality of simulated quote messages 610 and a plurality of simulated trade messages 612.

Among other data, the previously collected data 604 may include market data, order data, quote data, trade data and position data. The market data is reconstructed from stored incremental market data changes previously collected from at least one electronic market place. Due to efficient implementation of the data reconstruction routines, and use of an economical storage format, the data player 602 provides the market data at a simulator speed that is exponentially greater than a speed at which the incremental market data changes are stored. This enables an executing trading strategy to be back-tested at a “simulation-speed” that is much faster than a “real-time” speed. For example, back-testing an executing trading strategy by the algorithmic trading system 600, using a year's worth of market data, may only take a few hours. In an alternate embodiment, the data player 602 may be configured to back-test an executing trading strategy at a simulation-speed that is slower than the real-time speed.

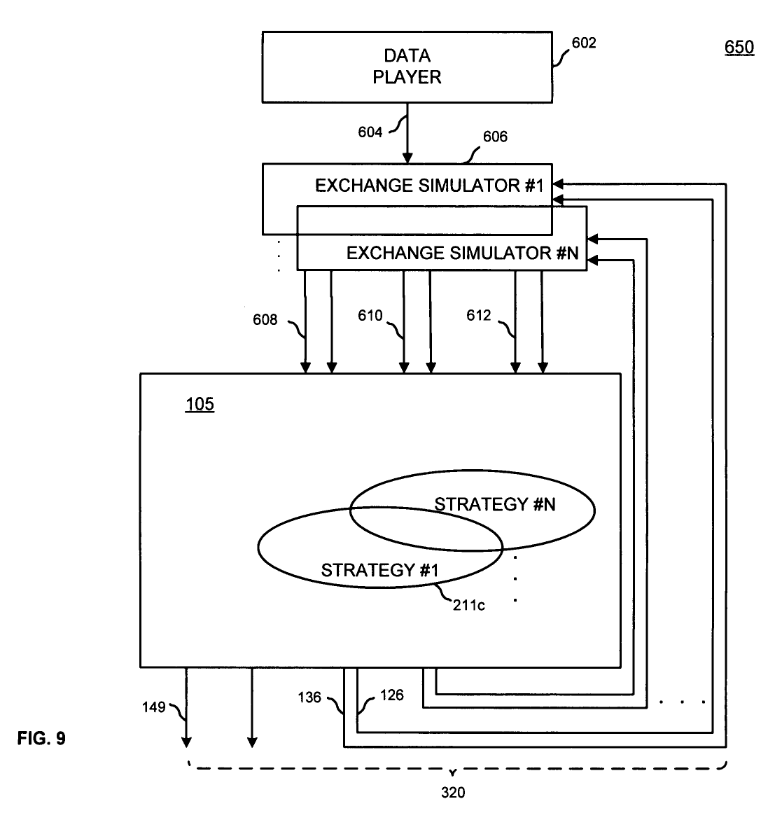

Due to an ability to have multiple exchange simulators operating with one data player 602, the algorithmic trading system 600 can concurrently and independently back-test a number of executing trading strategies (i.e., parallel back-testing) as illustrated in FIG. 9. That is, rather than running through the data for each parameter variation, one data run-by-one data run, the algorithmic trading system 600 can simulate the outcome of a number of concurrently executing trading strategies that include the same instrument(s) but different parameter values (variations). This feature increases the speed at which parameters can be optimized.

Further, the algorithmic trading system 600 considers every order book update, (i.e., not only tick data) during back-testing of an executing trading strategy, which makes it a highly precise tool compared to prior art algorithmic trading systems. The algorithmic trading system 600 is also configured to enable all common market models (e.g., price-time, pro rata) to be simulated in the same precise way to yield optimized back-testing results. In addition, the algorithmic trading system 600 is configured to compute every order book update and transaction round trip time within microsecond accuracy.

The algorithmic trading system 600 provides enhanced performance over prior art systems, especially when performing optimization back-testing runs to determine the ‘best’ parameter setting(s) for a trading strategy(ies) over a given time period. These optimization back-testing runs are characterized by a large number of user selected parameter variations (i.e., parameter combinations) in order to maximize a monetary return. Unlike the algorithmic trading system 600, known prior art algorithmic trading systems handle this process by back-testing one set of parameter values against the historic data, writing the results to the disk and performing the next run with a varied (i.e., changed) set of parameter values; run-by-run. This prior art serial procedure is cumbersome and highly inefficient due to the limited capacities of reading data from the system's disk. The algorithmic trading system 600 however, handles this task through performing back-testing using all possible parameter value variations in parallel. This parallel capability reduces the reading of historic data to a minimum and speeds up the back-testing process dramatically. Accordingly, the algorithmic trading system 600 is able to perform back-test runs at speeds exponentially faster than real time.

The fast speeds achieved by the algorithmic trading system 600 are the result of its ability to “calculate” a new market data state by adding net changes to the previous market data state. For example, if the market data consists of 20 market depth ranks for each bid and ask, and only the best ask rank changes, the algorithmic trading system 600 processes that change, which is represented by the rank's price/qty, rather than processing all 19 unchanged ranks

The algorithmic trading system 600 is a fully integrated (e.g., user terminal 110, AST computer 105, exchange simulator 606 and data player 602) so all developed rules and trading strategies can be easily accessed by the user. As described below, valid trading strategies can be back-tested via a single mouse click, where all parameter value variations are used automatically for creating trading strategies according to the list of values assigned to each parameter.

Maximum flexibility is provided to the user by freely programmable monitoring and performance figures/screens as part of the rule code using the published expressions (see, FIG. 5).

The results of the back-testing runs by the algorithmic trading system 600 are stored in a common human-readable format (e.g., .xml format, csv format), in for example, a memory portion of the ATS computer 105. The stored back-testing runs can then be used for a number of purposes, including future integration of 3^{rd} party analysis tools, user analysis, etc.

As discussed above, the algorithmic trading system 600 is client-server based. This enables the processing of multiple runs from different users simultaneously. Also, though the functionality of the algorithmic trading system 600 is fully integrated from a user's point of view, the functionality provided by the ATS computer 105 and the data player 606 and/or the exchange simulator 606 may be included in different machines to eliminate the impact of the back-testing runs on the production system.

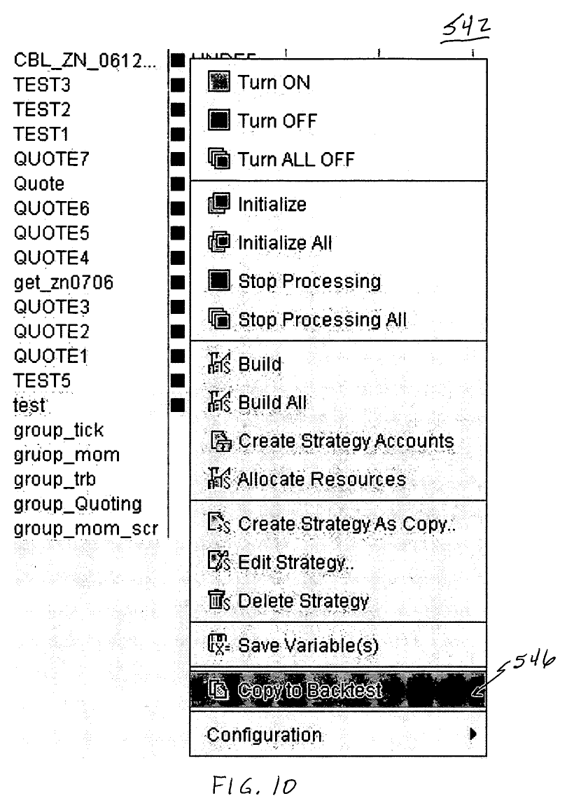

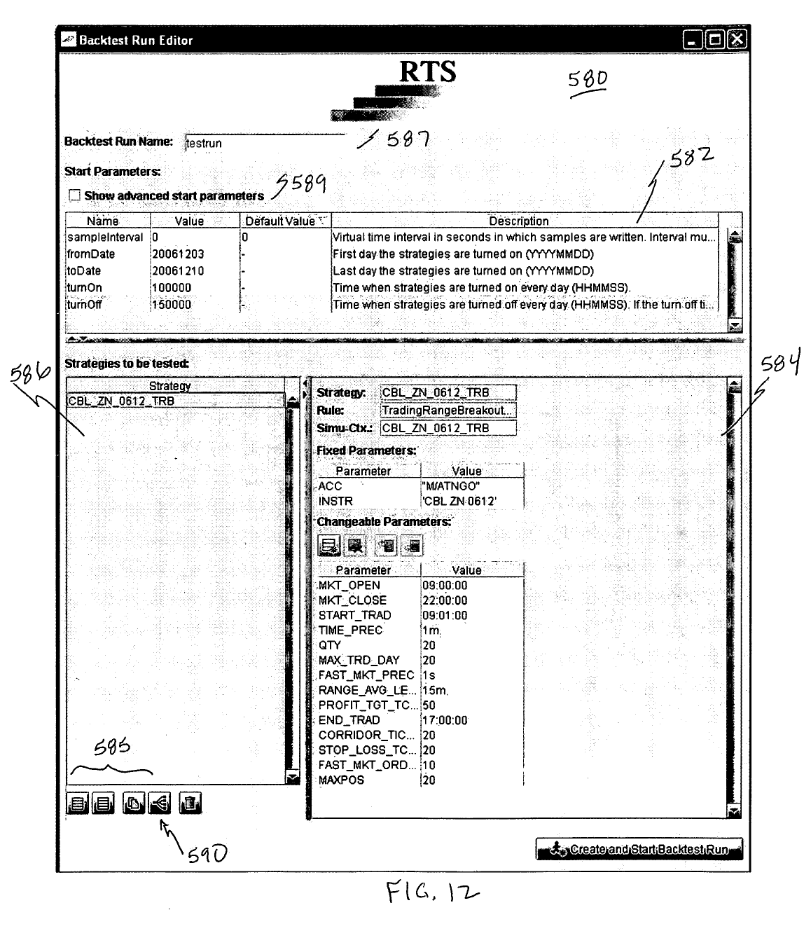

Referring again to FIG. 7, the back-test pull-down menu 542 includes a “copy to backtest” entry 546. FIG. 10 is an exemplary screen shot of a close-up view of the back-test pull-down menu 542. User selection (e.g. right mouse click) of the copy to backtest entry 546 invokes display of a backtest run editor 580, illustrated as FIG. 11, according to an embodiment of the invention. The backtest run editor 580 enables the user to assemble a set of trading strategies intended for back-testing using one of two methods. In the first method, the user can select and copy the trading strategies from the live trading client 114 in order to build the set of trading strategies to be back-tested. In the second method, the user can generate the set of trading strategies via a “backtest run strategy generator” window (see, FIG. 13), invoked by the user via the backtest run editor 580. The backtest run editor 580 also allows the user specify the back-test time period (fromDate, toDate) and the time(s) at which the trading strategies should start and stop processing for a particular back-test run (startTime, stopTime). Also, by providing an unique back-test run name, a “create backtest run” command enables the user to submit the start of a new back-test run with the set of trading strategies on the ATS computer 105.

Additional back-testing details and functionality may be best illustrated using a series of screen shots, depicting a workflow for back-testing one executing trading strategy such as the executing trading strategy 211c.

Referring again to FIG. 11, the selected trading strategy is copied and displayed in a strategy permutation window 586 of the backtest run editor 580. All of the selected trading strategy's fixed and changeable parameters are displayed in a modify strategy window 584 (analogous to the create strategy editor 560 of FIG. 6). As a result, the trading strategy setup, including the trading strategy name, the rule used, the simulation context and the fixed and changeable parameters are displayed in the lower portion of the backtest run editor 580. These are modifiable by the user in order to vary fixed and/or changeable parameter values for the back-tested trading strategy.

The upper portion, or the mandatory parameter window 582, includes the mandatory parameters (except ‘sampleInterval’) that must be specified for the back-test run. Further, by selecting a show advanced start parameters box 589, additional optional parameters may be displayed. Two of a number of back-testing control buttons 585 on the lower right side of the backtest run editor 580 enable the user to select either a unique simulation context for each trading strategy to be back-tested (i.e., all trading strategies are tested in parallel without affecting each other's outcome), or a same simulation context for each trading strategy to be back-tested (i.e., all trading strategy are tested in parallel and affect each other's outcome). Other back-testing control buttons 585 enable the user to duplicate strategy configurations, and to modify a particular trading strategy with variations in the fixed and/or changeable parameter values reflected in the Modify Strategy window 584.

To begin a back-test run, a user must assign a unique name via a backtest run name window 587. Below that entry, the user then specifies values for the start parameters of the mandatory parameter window 582. Descriptions of each of the start parameters are listed in the right hand column of the mandatory parameter window 582. For example, the “sampleInterval” start parameter determines a time interval in which sample files—including intermediate back test results as of the historic time point of the sample—is written and stored. The default setting of 0 indicates, that only at the end of each day, such a sample is written. The start parameter “Init” determines the time when the trading strategy is initialized, which is necessary for all trading strategies before executing them. The “skippedWeekDays” start parameter determines a comma-separated list of numbers from 0 to 6, representing the days that will be skipped every week. By default every Sunday and Saturday is skipped. There must be at least one day that is not skipped (Sunday=0, Monday=1, etc. The start parameter entry “Iv1” determines which types of messages are written to the back-test's logfile (1 indicates errors only while 2 indicates errors and warnings. The start parameter entry “haltOnError” causes a back-test run to halt automatically on the first occurrence of trading strategy errors, like exceptions

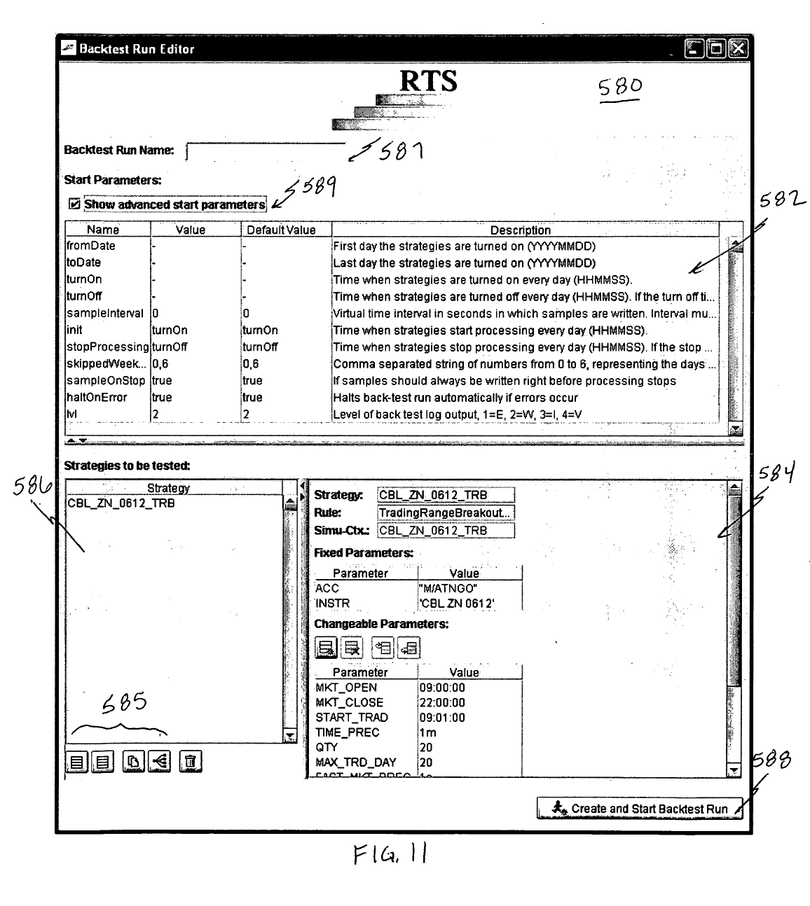

As discussed above, the user may choose to vary the fixed and/or changeable parameter values displayed in the modify strategy window 584. FIG. 12 is another view of the backtest run editor 580. As illustrated, the user has specified parameter values for the changeable parameters in the modify strategy window 584. For those parameters that the user wishes to vary, a semicolon is used to separate different parameter values. Because there are no constraints on which parameters are supported, each parameter can be assigned a number of values which will be used to generate variations of the executing trading strategy.

Upon completion of parameter value entry, the user may select a generate variations button 590 from the number of back-testing control buttons 585. FIG. 13 is an exemplary screen shot of a backtest run strategy generator 592 that is displayed to the user upon selection of the generate variations button 590, according to an embodiment of the invention. In addition to the information displayed in the modify strategy window 584, the backtest run strategy generator 592 further includes a test strategy variations field 593 adapted to display a numerical indication of the trading strategy variations (e.g., 100) selected by the user. It also includes the generate variations button 590 shown on the backtest run editor 580.

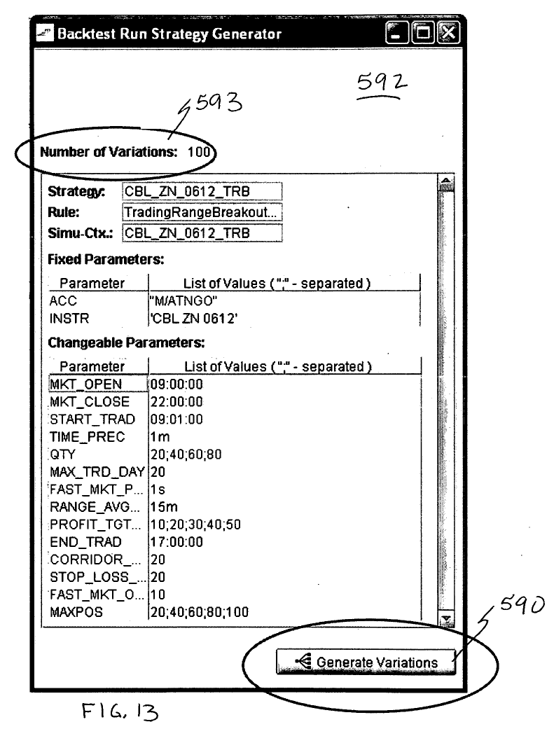

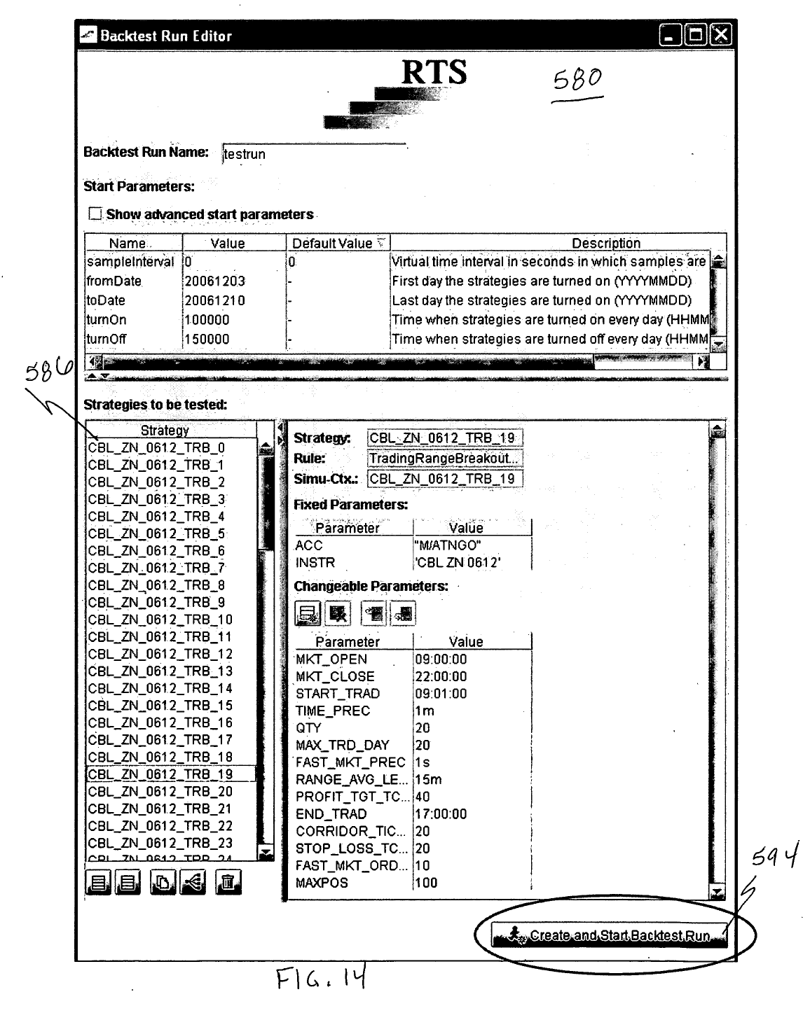

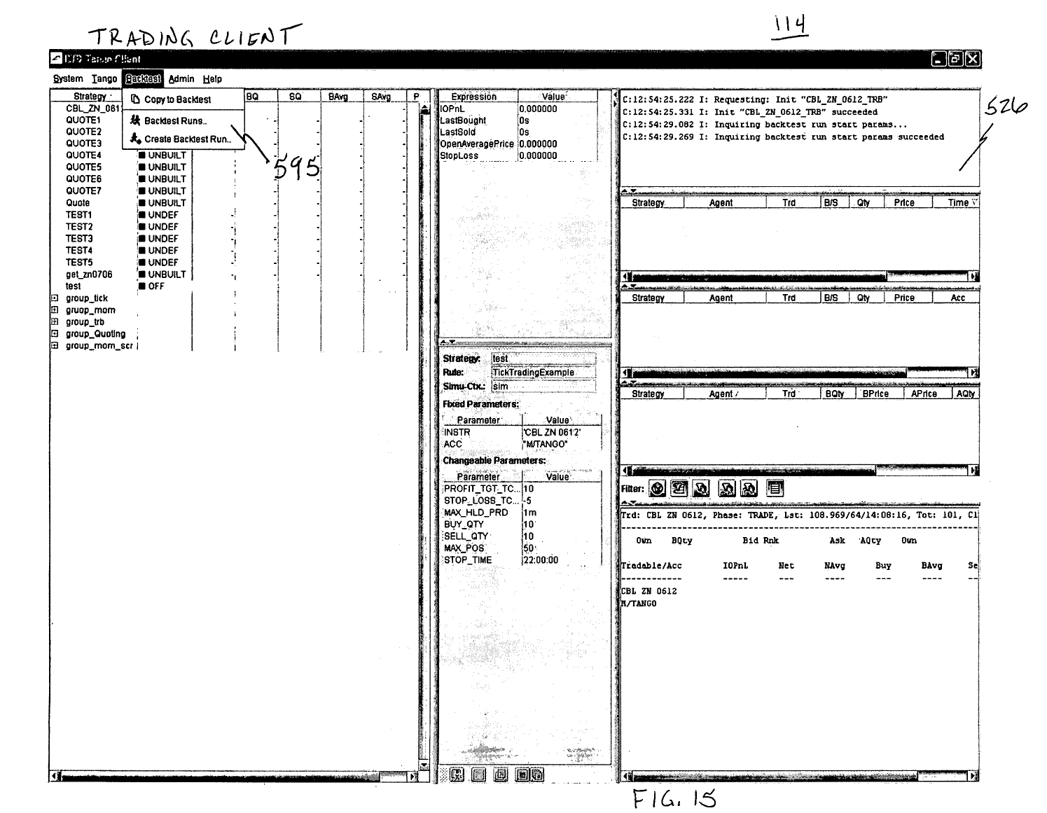

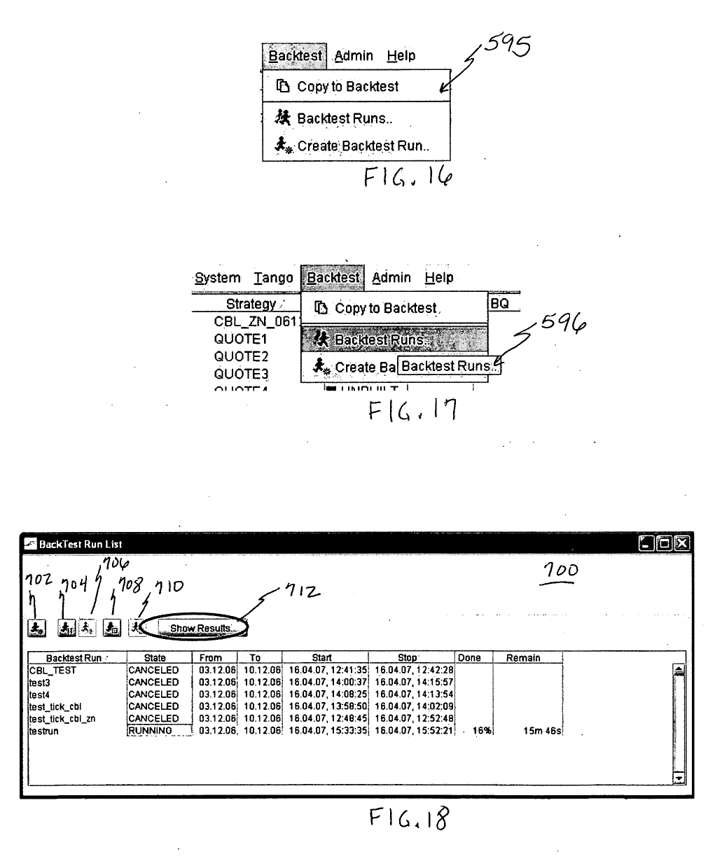

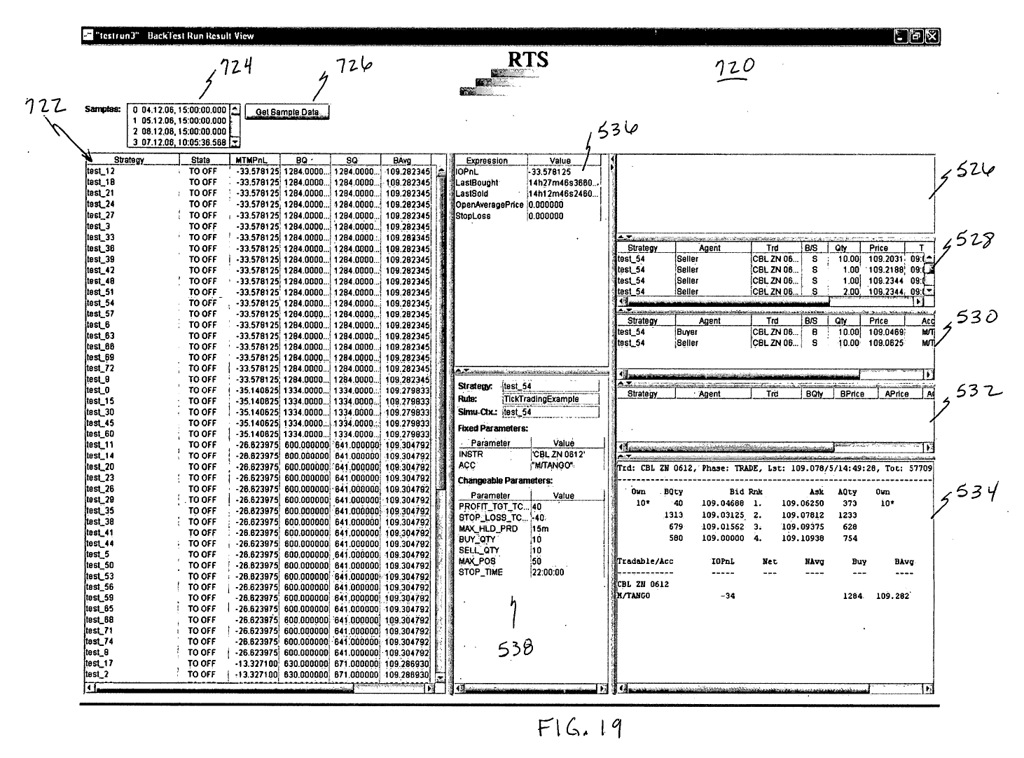

User selection of the enlarged generate variations button 590 of FIG. 13 causes display of each of the trading strategy variations to be back-tested. For example, FIG. 14 is another exemplary view of the backtest run editor 580, including the list of the trading strategy variations to be back-tested. As illustrated, the list of the trading strategy variations is displayed in the strategy permutation window 586. In this example, each variation in the list is labeled with a consecutive numerical suffix. At this point, the user can specify either a unique simulation context where all trading strategies are tested in parallel without affecting each other's outcome, or specify a same simulation context where all trading strategies are tested in parallel and affect each other's outcome via the back-testing control buttons 585. Back-testing of each of the list of the trading strategy variations begins upon user selection of the create and start backtest run button 594.

A user may view the results of completed back-testing of the trading strategy variations via the trading client 114. FIG. 15 is another exemplary screen shot of the trading client of FIG. 5, including a close-up view of a copy to back-test pull-down menu 595 (see, FIG. 16). FIG. 17 is a further close-up view of a copy to back-test pull-down menu 595 illustrating a user selectable “backtest runs” menu item 596.

An exemplary screen shot of a back-test run List 700, illustrated in FIG. 18, is displayed upon user selection of the “backtest runs” menu item 596. The back-test run list 700 is overview window for displaying the existing back-test runs. It displays a list of all back-test runs, including current states and progress, in a compact form. Each entry in the back-test run list 700 represents an individual back-test run and includes the back-test run name, a status of the back-test run (e.g., cancelled, running), a from back-test run date, a to back-test run date, a start time of the back-test run, an end time of the back-test run. For back-test runs that are running, the back-test run list 700 further includes a percentage complete and an estimated remaining time. It can be noted that, other than the last two columns of the back-test run list 700, the information displayed in the back-test run list 700 was previously entered by the user via the trading client 114 when setting up the back-test run(s) in the back-test run editor (see, FIG. 11).

Five buttons are displayed in the left upper portion of the exemplary back-test run list 700. User selection of a create back-test run button 702 enables the user to open the backtest run editor (see, FIG. 11) in order to create new back-test runs; user selection of a suspend back-test run button 704 enables the user to suspend a back-test run; user selection of a resume back-test run button 706 enables the user to resume a previously suspended back-test run; user selection of a cancel back-test run button 708 enables the user to (permanently) cancel a back-test run; and user selection of a delete back-test run button 710 enables the user to delete a back-test run from the back-test run list 700.

User selection (e.g., mouse click) of an entry from the list of all back-test runs, followed by user selection of a show results button 712 of the back-test run list 700 enables display of detailed results of an individual back-test run. FIG. 19 is an exemplary screen shot of a backtest run result view 720. As illustrated, the backtest run result view 720 includes a list of all back-tested trading strategy variations 722 for a particular back-test run. In the illustrated example of FIG. 19, each back-tested trading strategy variation is depicted in a format of “test” followed by a number (e.g., test_56) however, many other formats are possible.

An additional list of “date-time” samples 724 from which the desired date-time sample can be chosen is shown in the upper left portion of the view. These date-time samples 724 are identified by the date and time that they were written (i.e., the time point of the historic data not the time when it was actually written and stored to the system's disk). Recall, that the user can specify the sample intervals via the backtest run editor 580 (see, FIG. 11).

Upon user selection of a date-time sample from the samples 724, followed by user selection of a get sample data button 726, the windows on the right hand side and middle of the backtest run result view 720 are populated depending on the trading strategy associated with that back-test run. As a result, the user is able to view detailed information on each (simulated) trading strategy back-test run on a per sample time basis.

For example, based on user selection of a particular date-time sample, the filled orders window 528 may display completed/matched orders and/or quotes, the working orders window 530 may display current working orders, the working quotes window 532 may display current working quotes, and the market depth overview window 534 may display a trade summary of a trading strategy. Further, the first center window 536 may display the user-selected detailed published expressions, and the second center window 538 may display the parameter details, the strategy and rule name details of a trading strategy.

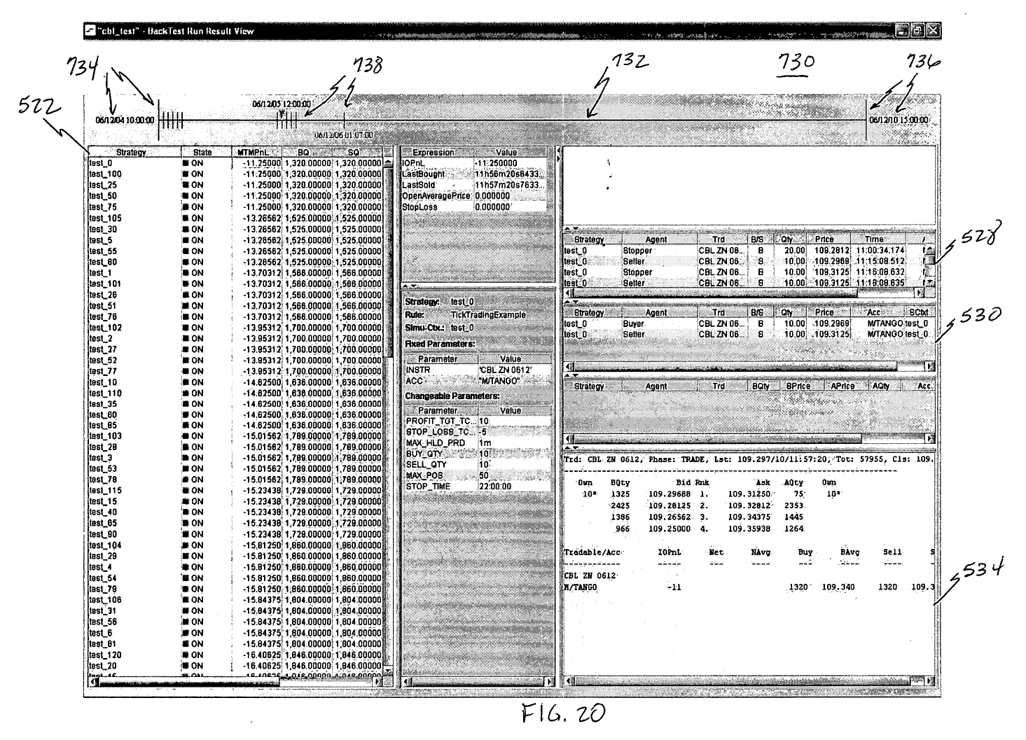

In some case it may be desirable to have a visual interactive tool to assist in viewing back-test run results. FIG. 20 is an exemplary screen shot of another version of the backtest run result view 730 that includes an interactive back-test run timeline 736. The interactive back-test run timeline 736 includes a series of vertical bars that intersect a horizontal bar at the top of the view. The first vertical bar is associated with a displayed back-test run start time 734 (e.g., Jun. 12, 2004 at 10:00:00), and the last vertical bar 736 is associated with a displayed back-test run end time 736. The start and stop times may be historic time and/or realtime values.

In addition, time samples of a back-test run are also displayed as additional time sample bars between the first (start) and last (end) bar, whereby the corresponding time points (historic and real) are displayed as a pop-up window when an indication associated with that particular time sample bar is received, in this case, a mouse pointer. bclicking with the left mouse button on one of the time sample bars causes the corresponding data to be displayed in the backtest run result view 730.

For a back-test run in progress (state RUNNING), that progress may be displayed as a bar that moves from left to right on the interactive back-test run timeline 736. As with the other mentioned bars, the moving bar is also labeled with the time indication (historic and real) of the most recent progress information disseminated by the server. Further, the estimated remaining time until completion is also displayed.

It should be understood that the present method may be implemented as a computer process, a computing system or as an article of manufacture such as a computer program product or computer readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process.

In one embodiment, the logical operations of the present method are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by persons skilled in the art that these operations, structural devices, acts and modules may be implemented in software, in firmware, in special purpose digital logic, and any combination thereof without deviating from the spirit and scope of the present invention as recited within the claims attached hereto.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

What is claimed is:

1. An algorithmic trading system for testing automated trading of financial instruments, the algorithmic trading system comprising:
a server computer adapted to:
store a rule for automated trading, the rule based on a trading strategy idea and including at least one parameter and at least one of an order agent and a quote agent,
store a trading strategy name and a parameter value for each of the at least one parameter,
store a created trading strategy, the created trading strategy including the rule, the parameter value for each of the at least one parameter and a trading strategy name,
compile the created trading strategy to form a generated trading strategy, and
process the generated trading strategy to form an executing trading strategy adapted to automatically cause a trading output;
a data player; and
at least one exchange simulator operatively coupled to the data player and the server computer.

2. The system of claim 1, wherein the executing trading strategy is adapted to automatically cause the trading output in response to an exchange simulator output, the exchange simulator output generated by the at least one exchange simulator in response to receipt of data from the data player.

3. The system of claim 2, wherein the trading output comprises at least one of a plurality of order transaction messages, a plurality of quote transaction messages and a plurality of variable definition values, and wherein the exchange simulator output comprises the data.

4. The system of claim 3, wherein the trading output comprises at least one of a different plurality of order transaction messages, a different plurality of quote transaction messages and a different plurality of variable definition values, and wherein the exchange simulator output comprises at least one of a plurality of simulated order messages, a plurality of simulated quote messages and a plurality of simulated trade messages.

5. The system of claim 2, wherein the server is further adapted to store additional rules for automated trading.

6. The system of claim 5, wherein the server is further adapted to process additional generated trading strategies to form concurrently executing trading strategies.

7. The system of claim 2, wherein the data is at least one selected from the group consisting of market data, order data, quote data, trade data and position data.

8. The system of claim 7, wherein the market data is reconstructed by the data player from stored incremental market data changes previously collected from at least one electronic market place.

9. The system of claim 8, wherein the data player is configured to provide the data to the at least one exchange simulator at a simulator speed that is greater than a speed at which the incremental market data changes are collected.

10. The system of claim 8, wherein the data player is configured to provide the data to the at least one exchange simulator at a simulator speed that is slower than a speed at which the incremental market data changes are collected.

11. The system of claim 1, wherein the financial instruments are selected from the group consisting of stock, equities, futures, options, commodities, bonds, currency and warrants.

12. The system of claim 1, wherein the order agent is adapted to issue and manage order additions, order deletions and order changes, and wherein the quote agent is adapted to issue and manage quote additions, quote deletions and quote changes.

13. The system of claim 1, further comprising a user client terminal operatively coupled to the server, the user client terminal including a rule development client and a trading client.

14. The system of claim 13, wherein the rule development client is adapted to enable a user to create and display the rule via a rule editor using arithmetic operators, logic operators, built-in functions and control structures.

15. The system of claim 14, wherein the rule development client is further adapted to display a rule template via the rule editor for use in creating the rule, the rule template including a parameter template portion, a variable definition template portion, an off condition template portion, a script template portion, an agent template portion, and a published expressions template portion.

16. The system of claim 13, wherein the trading client is adapted to display a list of created, generated and executing trading strategies, and wherein each of the created, generated and executing trading strategies of the list is selectable by the user.

17. The system of claim 13, wherein the trading client is further adapted to enable compilation initiation of a user-selected created trading strategy, to enable initialization of a user-selected generated trading strategy prior to processing by the interpreter unit, and to enable processing initiation of the user-selected generated trading strategy after initialization.

18. The system of claim 13, wherein the trading client is further adapted to enable user selection of the rule and to enable user input of the parameter value and the trading strategy name to form the created trading strategy.

19. The system of claim 13, wherein the trading client is further adapted to enable the user to initiate and monitor back-testing of at least one executing trading strategy via a Backtest Run editor.
